(19) United States
(12) Patent Application Publication
(10) Pub. No.: US 2026/0150029 A1
(43) Pub. Date: May 28, 2026

(54) METHODS FOR LOCAL WIRELESS TRANSMIT/RECEIVE UNIT (WTRU)-TO-WTRU RELAY RESELECTION WITH INTEGRATED DISCOVERY

(71) Applicant: InterDigital Patent Holdings, Inc., Wilmington, DE (US)

(72) Inventors: Joe Huang, Montville, NJ (US); Jung Je Son, Warrington, PA (US); Sudhir Pattar, Mount Laurel, NJ (US); Kyle Jung-Lin Pan, Saint James, NY (US); Phillip Leithead, King of Prussia, PA (US)

(73) Assignee: InterDigital Patent Holdings, Inc., Wilmington, DE (US)

(21) Appl. No.: 18/963,480

(22) Filed: Nov. 27, 2024

(51) Int. Cl. H04W 40/22; H04W 88/04

(52) U.S. Cl. CPC H04W 40/22; H04W 88/04

(57) ABSTRACT

Methods, apparatuses, devices, and procedures for wireless transmit/receive unit (WTRU)-to-WTRU relay reselection with integrated discovery are provided. A WTRU detects failure of a first link with a first relay WTRU. The WTRU determines, based on a unicast routing table, one or more peer WTRUs routable via the first relay WTRU. The WTRU establishes a second link with a second relay WTRU capable of routing to the one or more peer WTRUs. The WTRU transmits a direct communication request (DCR) message and/or a link modification request (LMR) message to the second relay WTRU. The WTRU receives, from the second relay WTRU, a direct communication accept (DCA) message and/or a link modification accept (LMA) message. The WTRU transmits a link modification notification (LMN) message to the one or more peer WTRUs via the second relay WTRU.

### STATEMENT OF GOVERNMENT RIGHTS

This invention was made with Government support under Contract No. N00014-21-C-1080 awarded by the Office of Naval Research. The Government has certain rights in the invention.

### BACKGROUND

In wireless communication networks such as fifth generation (5G) networks, 5G proximity services (ProSe) and/or 5G device-to-device (D2D) applications may be used. In 5G ProSe and/or 5G D2D applications, one or more relay connections may be setup between multiple devices. In multi-hop relays, a source device may discover one or more remote end devices and communicate with the one or more remote end devices via various types of relay links. When two end devices are connected via multi-hop relay links in a relay mesh network, the two end devices may use another set of relay links when a link fails between an end device and a relay device or between two relay devices. In such cases, triggering end-to-end relay reselection between every pair of the end devices causes excessive signal overhead and delays.

### SUMMARY

In various embodiments of the present disclosure, a wireless transmit/receive unit (WTRU) is provided. The WTRU comprises a memory, a transceiver, and a processor. The transceiver and the processor are configured to detect failure of a first link with a first relay WTRU. The transceiver and the processor are further configured to determine, based on a unicast routing table, one or more peer end WTRUs routable via the first relay WTRU. The transceiver and the processor are further configured to transmit a direct communication request (DCR) message and/or a link modification request (LMR) message targeting the one or more peer end WTRUs. The transceiver and the processor are further configured to receive, from the second relay WTRU that is capable of routing to the one or more peer end WTRUs, a direct communication accept (DCA) message and/or a link modification accept (LMA) message.

In an embodiment, the DCR message and/or the LMR message is indicative of one or more of: one or more identities of the one or more peer end WTRUs, or a quality of service (QoS) information set associated with the one or more peer end WTRUs.

In an embodiment, at least one of: the DCA message or the LMA message is indicative of one or more of: a first set of identities of a first set of peer end WTRUs that can be routed via the second relay WTRU, a second set of identities of a second set of peer end WTRUs that cannot be routed via the second relay WTRU, or a quality of service (QoS) information set between the WTRU and the second relay WTRU associated with the first set of peer end WTRUs.

In an embodiment, the transceiver and the processor are further configured to dynamically update, in a unicast routing table stored in the memory, one or more routes associated with the one or more peer end WTRUs.

In an embodiment, the transceiver and the processor are further configured to transmit a link modification notification (LMN) message to the one or more peer end WTRUs via the second relay WTRU.

In various embodiments, a method for use in a WTRU is provided. The method comprises detecting failure of a first link between a first relay WTRU. The method further comprises determining, based on a unicast routing table, one or more peer end WTRUs routable via the first relay WTRU. The method further comprises transmitting a direct communication request (DCR) message and/or a link modification request (LMR) message targeting the one or more peer end WTRUs. The method further comprises receiving, from the second relay WTRU, a direct communication accept (DCA) message and/or a link modification accept (LMA) message.

In various embodiments of the present disclosure, a WTRU is provided. The WTRU comprises a memory, a transceiver, and a processor. The transceiver and the processor are configured to receive, from a first end WTRU, a first direct communication request (DCR) message and/or a first link modification request (LMR) message. The first DCR message and/or the first LMR message is indicative of one or more identities of one or more peer end WTRUs of the first end WTRU. The transceiver and the processor are further configured to transmit a second DCR message and/or a second LMR message to the relay WTRU. The transceiver and the processor are further configured to receive, from the third relay WTRU, a second direct communication accept (DCA) message based on the second DCR message and/or receive, from the third relay WTRU, a second link modification accept (LMA) message based on the second LMR message.

In an embodiment, the DCR message and/or the LMR message is further indicative of: a quality of service (QoS) information set associated with the one or more peer end WTRUS.

In an embodiment, at least one of: the second DCR message or the second LMR message is indicative of one or more of: one or more identities of the one or more peer end WTRUs of the first end WTRU, or a quality of service (QoS) information set associated with the one or more peer end WTRUs of the first end WTRU.

In an embodiment, at least one of: the second DCA message or the second LMA message is indicative of one or more of: a first set of identities of a first set of peer end WTRUs that can be routed via the third relay WTRU, a second set of identities of a second set of peer end WTRUs that cannot be routed via the third relay WTRU, or a quality of service (QoS) information set between the WTRU and the third relay WTRU associated with the first set of peer end WTRUS.

In an embodiment, the transceiver and the processor are further configured to dynamically update the unicast routing table with one or more routes associated with the one or more peer WTRUs.

In an embodiment, the transceiver and the processor are further configured to transmit a first link DCA message and/or a first LMA message to the first end WTRU.

In an embodiment, at least one of: the first DCA message or the first LMA message is indicative of one or more of: a third set of identities of a third set of peer end WTRUs that can be routed via the WTRU, a fourth set of identities of a fourth set of peer end WTRUs that cannot be routed via the WTRU, or a quality of service (QoS) information set between the first end WTRU and the WTRU associated with the third set of peer end WTRUs

In an embodiment, the transceiver and the processor are configured to receive a link modification notification (LMN) message from the first end WTRU, and forward the LMN message to the one or more peer WTRUs.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example configuration for reselection with integrated discovery between an end WTRU and a responding U2U relay according to one or more embodiments;

FIG. 3 illustrates an example configuration for reselection with integrated discovery between an end device and a failure link peer U2U relay according to one or more embodiments;

FIG. 4 illustrates an example configuration for reselection with integrated discovery between a detecting device and a responding U2U relay according to one or more embodiments;

FIG. 5 illustrates an example configuration for reselection with integrated discovery between a precursor U2U relay and a next-hopU2U relay according to one or more embodiments;

FIG. 6 illustrates an example configuration for reselection with integrated discovery between a precursor U2U relay and a next-hopU2U relay according to one or more embodiments;

FIG. 7 is a call flow illustrating an example process for reselection with integrated discovery between an end WTRU and a responding U2U relay according to one or more embodiments;

FIG. 8 is a call flow illustrating an example process for reselection with integrated discovery between an end WTRU and a failure link peer U2U relay according to one or more embodiments;

FIG. 9 is a call flow illustrating an example process for reselection with integrated discovery between an end WTRU and a failure link peer U2U relay according to one or more embodiments;

FIG. 10 is a call flow illustrating an example process for reselection with integrated discovery between a precursor U2U relay and a next hop U2U relay according to one or more embodiments;

FIG. 11 is a call flow illustrating an example process for reselection with integrated discovery between a detecting U2U relay and an end WTRU according to one or more embodiments;

FIG. 12 is a flowchart illustrating a process for local WTRU-TO-WTRU relay reselection with integrated discovery according to one or more embodiments; and

FIG. 13 is a flowchart illustrating a process for local WTRU-TO-WTRU relay reselection with integrated discovery according to one or more embodiments.

### DETAILED DESCRIPTION

As discussed herein, one or more abbreviations in the following (non-exhaustive) list, shown in Table 1, may be used herein.

TABLE 1

| | |
|---|---|
| DCR | Direct Connection Request |
| DCA | Direct Connection Accept |
| LER | Link Establishment Request |
| LEA | Link Establishment Accept |
| LMR | Link Modification Request |
| LMA | Link Modification Accept |
| LMN | Link Modification Notification |
| LFN | Link Failure Notification |
| RSC | Relay Service Code |
| U2N Relay | User Equipment (UE)/Wireless |
| | Transmit/Receive Unit (WTRU) to Network |
| | Relay |
| U2U Relay | UE/WTRU to UE/WTRU Relay |

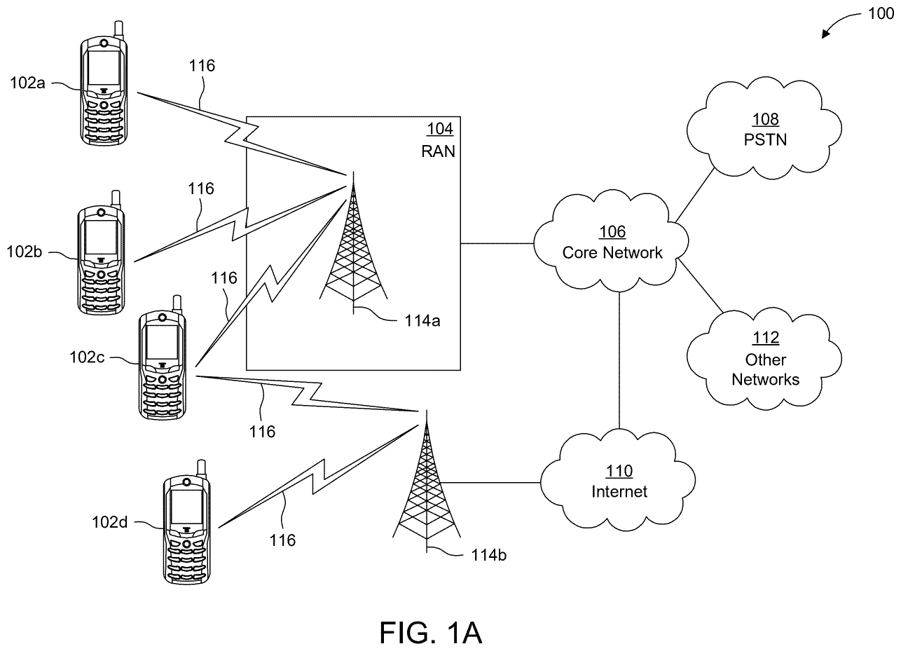

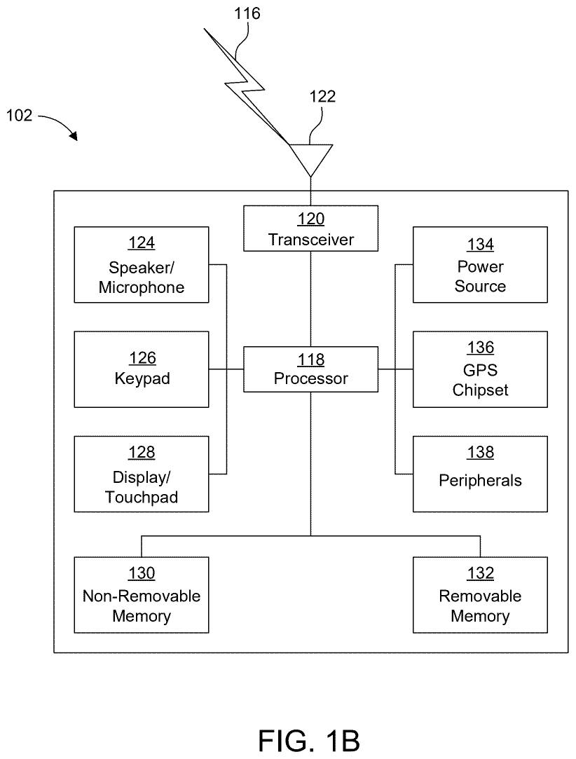

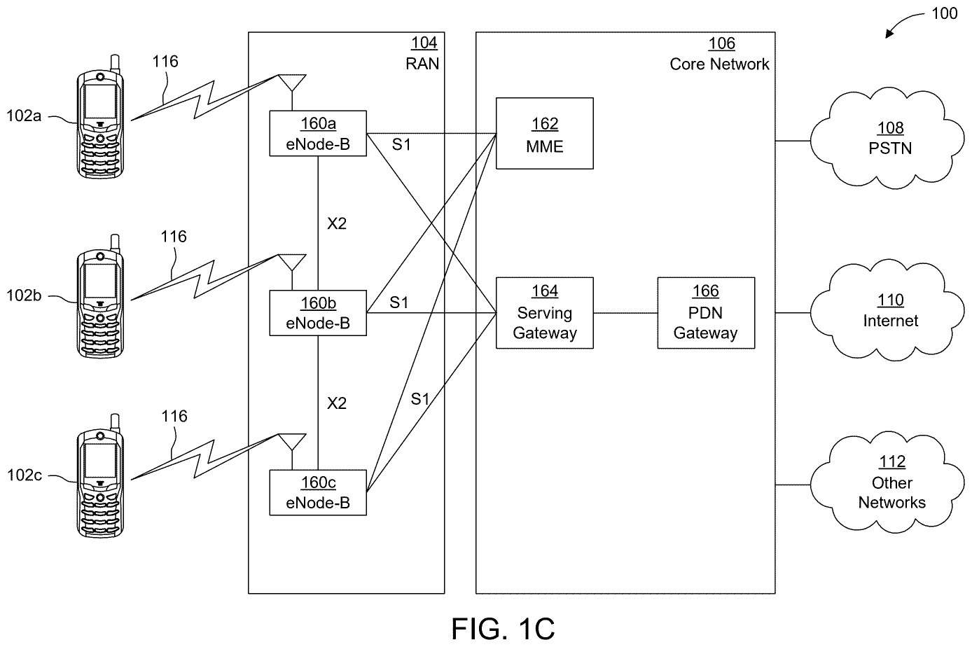

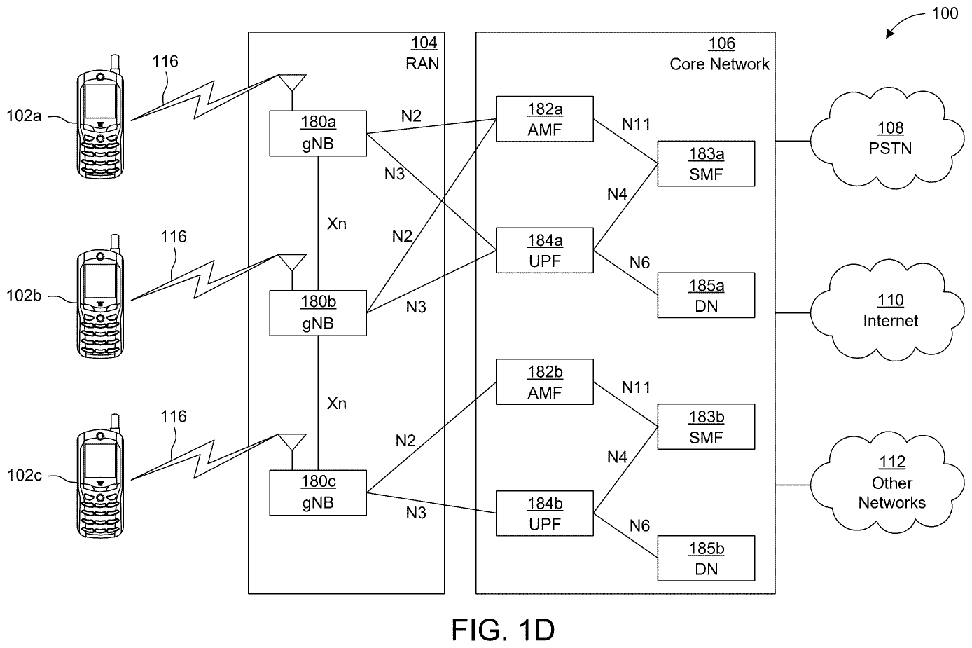

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In various embodiments of the present disclosure, one or more methods for multi-hop for WTRU-to-WTRU (U2U) relay are provided. In that, one or more methods for multi-hop U2U relay discovery and connection setup are provided. Further, one or more multi-hop U2U relay reselection procedures are provided.

In an embodiment, WTRU-to-WTRU relay discovery and PC5 setup is used. 5G ProSe provides several features and/or procedures such as 5G ProSe direct discovery, 5G ProSe direct communication, 5G ProSe WTRU-to-network relay, and/or 5G ProSe WTRU-to-WTRU relay etc. 5G ProSe WTRU-to-WTRU relay enables indirect communication between two end WTRUs. For WTRU-to-WTRU relay, 5G ProSe WTRU-to-WTRU relay discovery and 5G ProSe communication via WTRU-to-WTRU relay are provided.

For 5G ProSe WTRU-to-WTRU relay discovery, both model A and model B discovery are supported. Model A uses a single discovery protocol message (announcement). Model B uses two discovery protocol messages (solicitation and response). And, discovery integrated into PC5 unicast link establishment procedure is also supported.

5G ProSe Communication via WTRU-to-WTRU relay is possible with Layer 2 WTRU-to-WTRU relay or Layer 3 WTRU-to-WTRU relay. For Layer 2 WTRU-to-WTRU relay and Layer 3 WTRU-to-WTRU relay, 5G ProSe communication setup with discovery procedures is provided. Further, discovery integrated into PC5 unicast link establishment procedure is provided.

With Layer 2 WTRU-to-WTRU relay, an end-to-end PC5 link is established between the end WTRUs, via the relay. One or more PC5-S messages may be exchanged between the end WTRUs.

With Layer 3 WTRU-to-WTRU relay, each end WTRU may establish a PC5 link with the relay and the relay may forward the messages to the end WTRUs. The PC5-S messages may be exchanged between the end WTRUs and the relay.

With Layer 3 WTRU-to-WTRU relay, when an internet protocol (IP) based data connection is used, after a PC5 link setup with the relay, each end WTRU may be assigned an IP address by the relay which may be based on a dynamic host configuration protocol (DHCP) mechanism or each end WTRU may assign its own IP address, which may be based on link local IP address assignment mechanism, and may be informed to the relay. Whether DHCP or link local IP address assignment is used, may be determined during security connection setup between the end WTRU and WTRU-to-WTRU relay.

For WTRU-to-WTRU relay reselection, after connection setup between two end WTRUs via a WTRU-to-WTRU relay, each end WTRU may keep monitoring the channel status of the PC5 link and when a link quality goes below a threshold link quality, the end WTRU may select another WTRU-to-WTRU relay for the connection between the two end WTRUS.

For WTRU-to-WTRU relay reselection, one or more WTRU-to-WTRU relay discovery procedures may be used or a negotiated 5G ProSe WTRU-to-WTRU relay reselection procedure may be used.

In the negotiated WTRU-to-WTRU relay reselection, an end WTRU may initiate the WTRU-to-WTRU relay reselection procedure, the end WTRUs may negotiate a new WTRU-to-WTRU relay using the existing connection and establish the communication via the reselected WTRU-to-WTRU relay prior to releasing the communication via the current 5G ProSe WTRU-to-WTRU relay.

In multi-hop WTRU-to-network and WTRU-to-WTRU relay, the multi-hop WTRU-to-network relay may enable a remote WTRU to discover and communicate with a U2N relay via one or more U2U relays. multi-hop WTRU-to-WTRU relay may enable the end WTRUs to discover and communicate with each other via more than one U2U relay. The multi-hop capability is deemed crucial for mission critical communications (e.g., first responders) and in general needed to enhance coverage (e.g., indoor).

When two end WTRUs (WTRU-1 and WTRU-2) are connected via the multi-hop U2U relays in a WTRU-to-WTRU relay mesh network, the two end WTRUs may change to another set of U2U relays when the link between an end WTRU and a U2U relay or between two U2U relays becomes unavailable. Therefore, a solution is needed to mitigate different failure scenarios. In general, there may be multiple pairs of the end WTRUs inter-connected via the failed link. Although it is possible to trigger end-to-end (multi-hop) WTRU-to-WTRU relay discovery and/or multi-hop integrated discovery procedure between every pair of the end WTRUs, such an approach may not be efficient. To reduce a signaling overhead, it would be beneficial to have the capability to first perform local WTRU-to-WTRU relay reselection before resorting to end-to-end WTRU-to-WTRU relay reselection. Therefore, there is a need to perform local WTRU-to-WTRU relay reselections associated with multiple pairs of the end WTRUs when the end WTRU or a U2U relay detects a link failure with a neighbor U2U relay in a WTRU-to-WTRU relay mesh network.

In this disclosure, a WTRU-to-WTRU relay (U2U relay) may refer to a WTRU which may be authorized and behave as a relay WTRU to forward traffic between the end WTRUs. The multi-hop WTRU-to-WTRU relay discovery procedure may be performed by the end WTRU to discover a path to an announced WTRU (Model A) or a discoveree end WTRU (Model B) via one or more U2U relays.

A multi-hop WTRU-to-WTRU relay link establishment procedure may be used to set up a PC5 connection over the end-to-end path. After (multi-hop) WTRU-to-WTRU relay discovery, the initiating end WTRU may establish connectivity and/or modify an existing PC5 link with a U2U relay, through a direct communication request (DCR) and/or a link modification request (LMR). The U2U relay may establish connectivity with the next U2U relay along the discovered path, through a DCR and/or a LMR. The process may continue until the target end WTRU is reached. The target end WTRU may transmit a direct communication accept (DCA) and/or a link modification accept (LMA) to a selected U2U relay that the target end WTRU receives the DCR and/or LMR from. Each U2U relay along the selected reverse path may transmit the DCA and/or the LMA hop by hop. The end-to-end connectivity between the initiating end WTRU and the target end WTRU may be established when the DCA and/or LMA is received by the initiating end WTRU.

In an example, the initiating end WTRU may establish connectivity with the target end WTRU via end-to-end (multi-hop) integrated discovery. In this case, the initiating end WTRU may transmit the DCR and/or the LMR to discover the target end WTRU without relying on WTRU-to-WTRU relay discovery, while the DCA and/or the LMA may be transmitted back via the U2U relays along the selected reverse path to establish end-to-end connectivity.

In a local WTRU-to-WTRU relay reselection with integrated discovery, a source end WTRU or a source U2U relay may transmit the DCR and/or the LMR and/or the LER to discover a target WTRU relay while the DCA and/or the LMA and/or the LEA is transmitted back to the selected U2U relay.

The link establishment request (LER) and/or link establishment accept (LEA) messages may be used for setting up one or more PC5 connections for WTRU-to-WTRU relay communication, similar to the direct communication request (DCR) and/or the direct communication accept (DCA) messages. For the DCR and/or the DCA, both the source WTRU and the target WTRU may be end WTRUs. On the other hand, for LER and/or LEA, either the source WTRU or the target WTRU (or both) may be a U2U relay (or U2U relays).

When a U2U relay detects PC5 link failure, it may transmit a link failure notification (LFN) message to the end WTRUs on the same side of the detecting U2U relay relative to the failure link, and previously routed from the failure link, or precursors of the end WTRUs on the opposite side of the detecting U2U relay relative to the failure link, previously routed through the failure link.

Upon the completion of local WTRU-to-WTRU relay reselection and the corresponding link establishments to repair a portion of the end-to-end path, a U2U relay or an end WTRU may transmit a link modification notification (LMN) message to one or more end WTRUs to facilitate one or more unicast routing table updates along the end-to-end path and any follow-up Layer 3 and/or Layer 2 end-to-end connection and/or configuration updates, as needed.

The unicast routing table (per relay service code) may be used in the PC5 singling plane (PC5-S) and may be set up during a link establishment procedure. Upon the reception of a LMR message and/or in a security procedure after receiving a DCR message, the U2U relay or the end WTRU may add an entry to the unicast routing table to the source end WTRU, with a destination set to user information identifier (ID) of the source end WTRU, and next-hop user information ID and/or a Layer 2 ID set to a sender user information ID and/or a source Layer 2 ID of the received message. Upon the reception of the DCA message and/or the LMA message, a U2U relay or an end WTRU may add an entry to the unicast routing table to the target end WTRU, with destination set to user info ID of the target end WTRU and next-hop user information ID and/or Layer 2 ID set to the sender user information ID and/or source layer 2 ID of the received message.

In this disclosure, precursor may refer to a neighbor U2U relay or an end WTRU that uses the current U2U relay as the next hop towards a destination end WTRU in the unicast routing table. There may be multiple precursors associated with a destination end WTRU.

In a quality of service (QoS) context of unicast routing table for each destination end WTRU in the unicast routing table of a U2U relay, the QoS context may be recorded. The QoS context may include, for the destination end WTRU being the source end WTRU during end-to-end link establishment, a list of peer target end WTRUs associated with the destination end WTRU being the source end WTRU, a list of QoS information between the current U2U relay and each target end WTRU. For destination end WTRU being the target end WTRU during end-to-end link establishment, a list of peer source end WTRUs associated with the destination end WTRU being the target end WTRU and a list of QoS information between the current U2U relay and the destination end WTRU associated with each peer source end WTRU.

In an embodiment, a wireless communication system may include a plurality of devices, including but not limited to one or more relay devices, one or more end devices, and/or one or more intermediate end devices. In an example, the relay devices, end devices, and/or intermediate end devices may include but are not limited to WTRUs, 5G WTRUS, such as 5G ProSe enabled WTRUs etc. A first relay device may detect a link failure for a first link between the first relay device and a second relay device. The first relay device may perform the local integrated discovery targeting one or more downstream end devices originally routed through the failed link (here, a second end device). A third relay device, knowing an active route to any of the downstream end devices (here, the second end device), may respond to the first relay device with the connection setup (here, via a fourth relay device. After the alternative connection has been setup between the first relay device and the third relay device, the first relay device may notify one or more upstream end devices (here, a first end device) and the one or more downstream end devices (here, the second end device) originally routed through the failed link and the third relay device.

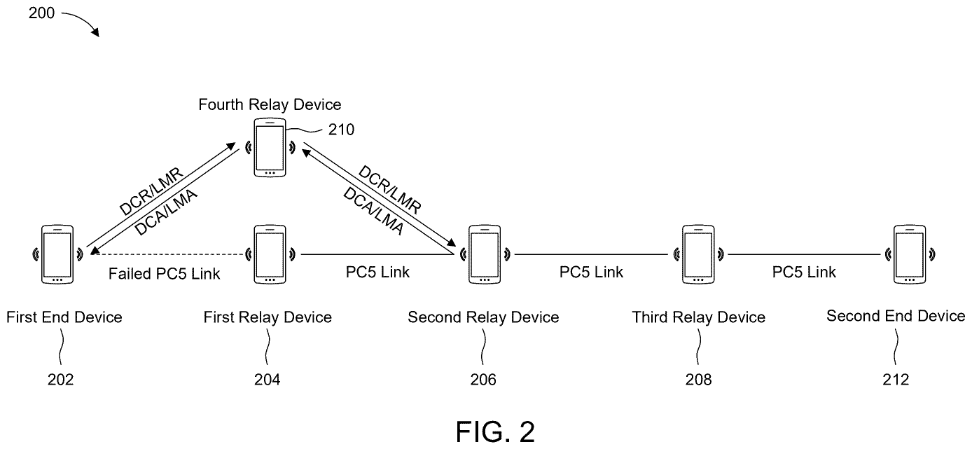

Referring now to FIG. 2, a communication system 200 illustrating an example configuration for reselection with integrated discovery between an end WTRU and a responding U2U relay is shown according to one or more embodiments. The communication system 200 may include a first end device 202, a first relay device 204, a second relay device 206, a third relay device 208, a fourth relay device 210, and a second end device 212. Examples of the first end device 202, the first relay device 204, the second relay device 206, the third relay device 208, the fourth relay device 210, and the second end device 212 include but are not limited to one or more WTRUs, 5G ProSe enabled WTRUs, and/or D2D enabled WTRUs etc. Further, the first end device 202, the first relay device 204, the second relay device 206, the third relay device 208, the fourth relay device 210, and the second end device 212 may include but are not limited to one or more devices in vehicles and/or carried by pedestrians, one or more network devices and/or infrastructure devices etc.

The first end device 202 may detect a link failure of a first link between the first end device 202 and the first relay device 204. The first end device 202 may perform the local integrated discovery targeting a list of peer end devices originally routed through the failure link (here, the second end device 212). The second relay device 206, knowing an active route to any of the peer end devices of the first end device 202 (here, the second end device 212), may respond to the first end device 202 with alternative connection setup (here, via the fourth relay device 210). After alternative connection setup between the first end device 202 and the second relay device 206, the first end device 202 may notify its peer end devices originally routed through the failure link (here, the second end device 212).

The first end device 202 (detecting and initiating end device) may detect the link failure between the first end device 202 and the first relay device 204. The first end device 202 may transmit the DCR message and/or the LMR message targeting the list of identified peer end devices that are originally routable via the first relay device 204 (here, the second end device 212). The first end device 202 may respond to the security establishment with the fourth relay device 210 after the DCR message. The first end device 202 may provide end-to-end QoS information set for the first end device 202 and the identified peer end devices of the first end device 202 (here, the second end device 212) to the fourth relay device 210 in the security procedure after the DCR message and/or in the LMR message. The first end device 202 may receive the DCA message and/or the LMA message from the fourth relay device 210, which may include information of the first end device 202 and a list of identified peer end devices of the first end device 202 that are routable by the second relay device 206. The first end device 202 may possibly request an internet protocol (IP) address from the fourth relay device 210. The first end device 202 may transmit a LMN message to the list of identified peer end devices received in the DCA message and/or the LMA message from the fourth relay device 210 (here, the second end device 212, via the fourth relay device 210). The first end device 202 may exchange traffic with the second end device 212 via the newly selected route between the first end device 202 and the second end device 212.

The first relay device 204 may be a failure link peer U2U relay.

The second relay device 206 (responding U2U relay) may receive the DCR message and/or the LMR message from the fourth relay device 210, which may include information of the first end device 202 and a list of identified peer end devices of the first end device 202 originally routed through the failure link. The second relay device 206 may establish security with the fourth relay device 210 if the PC5 connection between the second relay device 206 and the fourth relay device 210 has not been established. The second relay device 206 may transmit the DCA message and/or the LMA message to the fourth relay device 210, which may include information of the first end device 202 and a list of identified peer end devices of the first end device 202 that are routable by the second relay device 206, the QoS information set of the second relay device 206 for the first end device 202 and the identified peer end devices of the first end device 202 (here, the second end device 212). The second relay device 206 may receive the LMR message from the fourth relay device 210 for QoS flow setup and/or modification between the fourth relay device 210 and the second relay device 206. The second relay device 206 may transmit the LMA message to the fourth relay device 210 for QoS flow setup and/or modification, which may include the QoS information set between the fourth relay device 210 and the second relay device 206, for the first end device 202 and the identified peer end devices of the first end device 202 (here, the second end device 212). The second relay device 206 may receive the LMN message originated from the first end device 202, via the fourth relay device 210. The second relay device 206 may transmit the LMN message to a sub-list of identified peer end devices of the first end device 202 received in the LMN message from the fourth relay device 210 per next hop (here, the second end device 212, via the third relay device 208).

The third relay device 208 (U2U relay) may receive the LMN message originated from the first end device 202, via the second relay device 206. The third relay device 208 may transmit the LMN message to the sub-list of identified peer end devices of the first end device 202 received in the LMN message from the second relay device 206 per next hop (here, the second end device 212).

The fourth relay device 210 (alternative U2U relay) may receive the DCR message and/or the LMR message from the first end device 202, which may include information of the first end device 202 and the list of identified peer end devices of the first end device 202 originally routed through the failure link. The fourth relay device 210 may transmit the DCR message and/or the LMR message targeting the list of identified peer end devices of the first end device 202 (here, the second end device 212) received in the DCR message and/or the LMR message from the first end device 202. The fourth relay device 210 may respond to the security establishment with the second relay device 206 after the DCR message. The fourth relay device 210 may receive the DCA message and/or the LMA message from the second relay device 206, which may include information of the first end device 202 and the list of identified peer end devices of the first end device 202 that are routable by the second relay device 206. The fourth relay device 210 may establish security with the first end device 202 if the PC5 connection between the fourth relay device 210 and the first end device 202 has not been established. The fourth relay device 210 may determine the QoS information set between the first end device 202 and the second relay device 206, associated with the identified peer end devices of the first end device 202 (here, the second end device 212). The fourth relay device 210 may determine the QoS information set between the first end device 202 and the fourth relay device 210 and the QoS information set between the fourth relay device 210 and the second relay device 206, for the first end device 202 and the identified peer end devices of the first end device 202 (here, the second end device 212). The fourth relay device 210 may transmit the LMR message to the second relay device 206 for the QoS flow setup and/or modification, which may include the QoS information set between the fourth relay device 210 and the second relay device 206, for the first end device 202 and the identified peer end devices to the first end device 202 (here, the second end device 212). The fourth relay device 210 may receive the LMA message from the second relay device 206 for QoS flow setup and/or modification between the fourth relay device 210 and the second relay device 206. The fourth relay device 210 may transmit the DCA message and/or the LMA message to the first end device 202, which may include information of the first end device 202 and the list of identified peer end devices of the first end device 202 received in the DCA message and/or the LMA message from the second relay device 206, the QoS information set between the first end device 202 and the fourth relay device 210 associated with the identified peer end devices of the first end device 202 (here, the second end device 212). The fourth relay device 210 may receive the LMN message from the first end device 202. The fourth relay device 210 may transmit the LMN message to the list of identified peer end devices of the first end device 202 received in the LMN message from the first end device 202 (here, the second end device 212, via the second relay device 206).

The second end device 212 (peer end device) may receive the LMN message originated from the first end device 202, via the third relay device 208. The second end device 212 may exchange traffic with the first end device 202 via the newly selected route between the first end device 202 and the second end device 212.

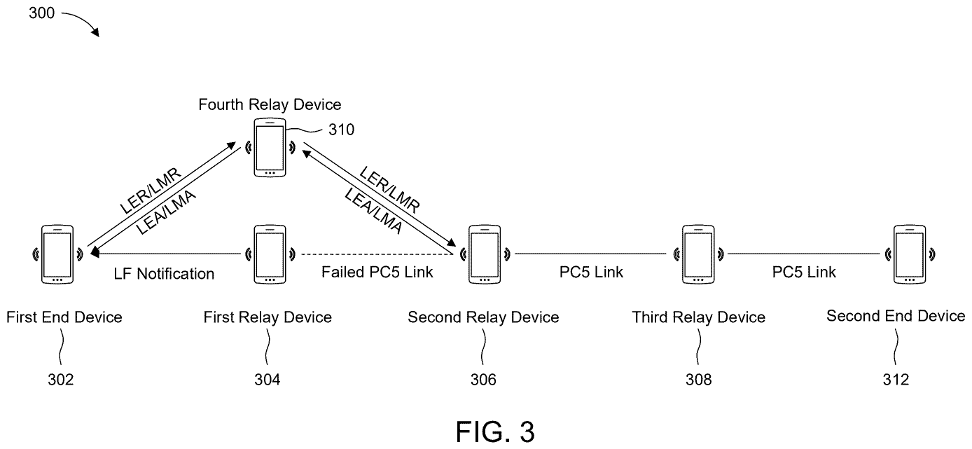

Referring now to FIG. 3, a communication system 300 illustrating an example configuration for reselection with integrated discovery between an end device and a failure link peer U2U relay is shown according to one or more embodiments. The communication system 300 may include a first end device 302, a first relay device 304, a second relay device 306, a third relay device 308, a fourth relay device 310, and a second end device 312. Examples of the first end device 302, the first relay device 304, the second relay device 306, the third relay device 308, the fourth relay device 310, and the second end device 312 include but are not limited to one or more WTRUs, 5G ProSe enabled WTRUs, and/or D2D enabled WTRUs etc. Further, the first end device 302, the first relay device 304, the second relay device 306, the third relay device 308, the fourth relay device 310, and the second end device 312 may include but are not limited to one or more devices in vehicles and/or carried by pedestrians, one or more network devices and/or infrastructure devices etc.

The first relay device 304 may detect a link failure between the first relay device 304 and the second relay device 306 and may notify one or more upstream end devices (here, the first end device 302) the information of its peer U2U relay of the failure link (here, the second relay device 306). The first end device may 302 perform local integrated discovery targeting the second relay device 306. After alternative connection setup between the first end device 302 and the second relay device 306 (here, via the fourth relay device 310), the first end device 302 may notify its peer end devices originally routed through the failure link (here, the second end device 312).

The first end device 302 (initiating end device) may receive a LFN message from the first relay device 304, which may include information of its peer U2U relay of the failure link (here, the second relay device 306), information of a list of identified upstream end devices (here, the first end device 302) and a list of identified downstream end devices (here, the second end device 312) originally routed through the failure link. The first end device 302 may transmit the LER message and/or the LMR message targeting the second relay device 306, which may include information of the first end device 302 and a list of identified peer end devices that are in the list of identified downstream end devices received in the LFN message from the first relay device 304 (here, the second end device 312). The first end device 302 may respond to the security establishment with the fourth relay device 310 after the LER message. The first end device 302 may provide end-to-end QoS information set for the first end device 302 and the identified peer end devices of the first end device 302 (here, the second end device 312) to the fourth relay device 310 in the security procedure after the LER message and/or in the LMR message. The first end device 302 may receive the LEA message and/or the LMA message from the fourth relay device 310, which may include information of the first end device 302 and the list of identified peer end devices of the first end device 302 that are routable by the second relay device 306. The first end device 302 may possibly request an IP address from the fourth relay device 310. The first end device 302 may transmit a LMN message to the list of identified peer end devices received in the LEA message and/or the LMA message from the fourth relay device 310 (here, the second end device 312, via the fourth relay device 310). The first end device 302 may exchange traffic with the second end device 312 via the newly selected route between the first end device 302 and the second end device 312.

The first relay device 304 (detecting U2U relay) may detect the link failure between the first relay device 304 and the second relay device 306. The first relay device 304 may transmit the LFN message to the list of identified upstream end devices (here, the first end device 302) originally routed through the failure link, which may include information of the list of identified downstream end devices (here, the second end device 312) originally routed through the failure link and failure link peer relay of the first relay device 304 (here, the second relay device 306).

The second relay device 306 (failure link peer and responding U2U relay) may receive the LER message and/or the LMR message from the fourth relay device 310, which may include information of the first end device 302 and the list of identified peer end devices of the first end device 302 originally routed through the failure link. The second relay device 306 may establish security with the fourth relay device 310 if the PC5 connection between the second relay device 306 and the fourth relay device 310 has not been established. The second relay device 306 may transmit the LEA message and/or the LMA message to the fourth relay device 310, which may include information of the first end device 302 and the list of identified peer end devices of the first end device 302 (here, the second end device 312) that are routable by the second relay device 306, QoS information set of the second relay device 306 for the first end device 302 and the identified peer end devices of the first end device 302 (here, the second end device 312). The second relay device 306 may receive the LMR message from the fourth relay device 310 for QoS flow setup and/or modification between the fourth relay device 310 and the second relay device 306. The second relay device 306 may transmit the LMA message to the fourth relay device 310 for QoS flow setup and/or modification, which may include the QoS information set between the fourth relay device 310 and the second relay device 306, for the first end device 302 and the identified peer end devices of the first end device 302 (here, the second end device 312). The second relay device 306 may receive the LMN message originated from the first end device 302, via the fourth relay device 310. The second relay device 306 may transmit the LMN message to the sub-list of identified peer end devices of the first end device 302 received in the LMN message from the fourth relay device 310, per next hop (here, the second end device 312, via the third relay device 308).

The third relay device 308 (U2U relay) may receive the LMN message that originated from the first end device 302, via the second relay device 306. The third relay device 308 may transmit the LMN message to the sub-list of identified peer end devices of the first end device 302 received in the LMN message from the second relay device 306, per next hop (here, the second end device 312).

The fourth relay device 310 (alternative U2U relay) may receive the LER message and/or the LMR message from the first end device 302, which may include information of the first end device 302 and the list of identified peer end devices of the first end device 302 originally routed through the failure link. The fourth relay device 310 may transmit the LER message and/or the LMR message targeting the second relay device 306, which may include information of the first end device 302 and the list of identified peer end devices of the first end device 302 received in the LER message and/or the LMR message from the first end device 302. The fourth relay device 310 may respond to the security establishment with the second relay device 306 after the LER message. The fourth relay device 310 may receive the LEA message and/or the LMA message from the second relay device 306, which may include information of the first end device 302 and the list of identified peer end devices of the first end device 302 (here, the second end device 312) that are routable by the second relay device 306. The fourth relay device 310 may establish security with the first end device 302 if the PC5 connection between the fourth relay device 310 and the first end device 302 has not been established. The fourth relay device 310 may determine the QoS information set between the first end device 302 and the second relay device 306, associated with peer end WTRU of the identified first end device 302 (here, the second end device 312). The fourth relay device 310 may determine the QoS information set between the first end device 302 and the fourth relay device 310 and the QoS information set between the fourth relay device 310 and the second relay device 306, for the first end device 302 and the identified peer end devices of the first end device 302 (here, the second end device 312). The fourth relay device 310 may transmit the LMR message to the second relay device 306 for the QoS flow setup and/or modification, which may include the QoS information set between the fourth relay device 310 and the second relay device 306, for the first end device 302 and the identified peer end devices of the first end device 302 (here, the second end device 312). The fourth relay device 310 may receive the LMA message from the second relay device 306 for the QoS flow setup and/or modification between the fourth relay device 310 and the second relay device 306. The fourth relay device 310 may transmit the LEA message and/or the LMA message to the first end device 302, which may include information of the first end device 302 and the list of identified peer end devices of the first end device 302 (here, the second end device 312) received in the LEA message and/or the LMA message from the second relay device 306, the QoS information set between the first end device 302 and the fourth relay device 310 associated with the identified peer end devices of the first end device 302 (here, the second end device 312). The fourth relay device 310 may receive the LMN message from the first end device 302. The fourth relay device 310 may transmit the LMN message to the list of identified peer end devices of the first end device 302 received in the LMN message from the first end device 302 (here, the second end device 312, via the second relay device 306).

The second end device 312 (peer end WTRU) may receive the LMN message originated from the first end device 302, via the third relay device 308. The fourth relay device 310 may exchange the traffic with the first end device 302 via the newly selected route between the first end device 302 and the second end device 312.

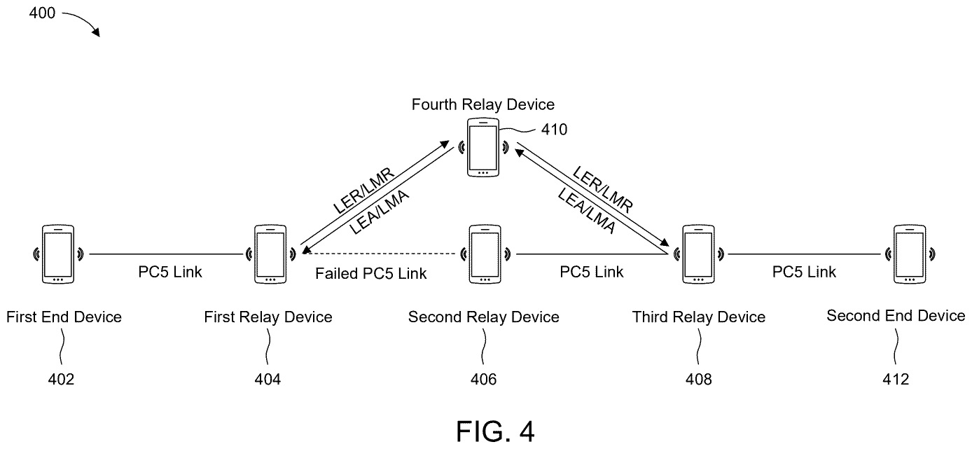

Referring now to FIG. 4, a communication system 400 illustrating an example configuration for reselection with integrated discovery between a detecting device and a responding U2U relay is shown according to one or more embodiments. The communication system 400 may include a first end device 402, a first relay device 404, a second relay device 406, a third relay device 408, a fourth relay device 410, and a second end device 412. Examples of the first end device 402, the first relay device 404, the second relay device 406, the third relay device 408, the fourth relay device 410, and the second end device 312 include but are not limited to one or more WTRUs, 5G ProSe enabled WTRUs, and/or D2D enabled WTRUs etc. Further, the first end device 402, the first relay device 404, the second relay device 406, the third relay device 408, the fourth relay device 410, and the second end device 412 may include but are not limited to one or more devices in vehicles and/or carried by pedestrians, one or more network devices and/or infrastructure devices etc.

The first relay device 404 may detect a link failure between the first relay device 404 and the second relay device 406. The first relay device 404 may perform a local integrated discovery targeting downstream end devices originally routed through the failure link (here, the second end device 412). The third relay device 408, knowing an active route to any of downstream end devices (here, the second end device 412), may respond to the first relay device 404 with connection setup (here, via the fourth relay device 410). After alternative connection setup between the first relay device 404 and the third relay device 408, the first relay device 404 may notify one or more upstream end devices (here, the first end device 402) and one or more downstream end devices (here, the second end device 412) originally routed through the failure link and the third relay device 408.

The first end device 402 (upstream end device) may receive a LMN message from the first relay device 404. The first end device 402 may exchange traffic with the second end device 412 via the newly selected route between the first end device 402 and the second end device 412.

The first relay device 404 (detecting and initiating U2U relay) may detect the link failure between the first relay device 404 and the second relay device 406. The first relay device 404 may determine the list of upstream end devices whose precursor is the second relay device 406 (here, the first end device 402) and the list of downstream end devices whose next hop is the second relay device 406 (here, the second end device 412). The first relay device 404 may determine the list of QoS information sets of the first relay device 404 for the list of identified downstream end devices (here, the second end device 412) and their identified upstream peer end devices (here, the first end device 402). The first relay device 404 may transmit the LER message and/or the LMR message, targeting the list of identified downstream end devices originally routed through the failure link (here, the second end device 412), which may include information of the list of identified upstream end devices originally routed through the failure link (here, the first end device 402). The first relay device 404 may respond to the security establishment with the fourth relay device 410 after the LER message. The first relay device 404 may provide a list of QoS information sets of the first relay device 404 for the list of identified downstream end devices (here, the second end device 412) and their identified upstream peer end devices (here, the first end device 402) to the fourth relay device 410 in the security procedure after the LER message and/or in the LMR message. The first relay device 404 may receive the LEA message and/or the LMA message from the fourth relay device 410, which may include information of the list of identified downstream end devices (here, the second end device 412) and the list of identified upstream end devices (here, the first end device 402) that are routable by the third relay device 408. The first relay device 404 may transmit the LMN message to a sub-list of identified upstream end devices (here, the first end device 402) received in the LEA message and/or the LMA message from the fourth relay device 410, per next hop. The first relay device 404 may transmit the LMN message to the list of identified downstream end devices (here, the second end device 412) received in the LEA message and/or the LMA message from the fourth relay device 410, via the fourth relay device 410.

The second relay device 406 may be a failure link peer U2U relay.

The third relay device 408 (responding U2U relay) may receive the LER message and/or the LMR message from the fourth relay device 410, which may include information of the list of identified downstream end devices (here, the second end device 412) and the list of identified upstream end devices (here, the first end device 402) originally routed through the failure link. The third relay device 408 may establish security with the fourth relay device 410 if the PC5 connection between the third relay device 408 and the fourth relay device 410 has not been established. The third relay device 408 may transmit the LEA message and/or the LMA message to the fourth relay device 410, which may include information of the list of identified downstream end devices (here, the second end device 412) and the list of identified upstream end devices (here, the first end device 402) that are routable by the third relay device 408, a list of QoS information sets of the third relay device 408 for the list of identified downstream end devices (here, the second end device 412) and their identified upstream peer end devices (here, the first end device 402). The third relay device 408 may receive the LMR message from the fourth relay device 410 for QoS flow setup and/or modification between the fourth relay device 410 and the third relay device 408. The third relay device 408 may transmit the LMA message to the fourth relay device 410 for QoS flow setup and/or modification, which may include the list of QoS information sets between the fourth relay device 410 and the third relay device 408 for the list of identified downstream end devices (here, the second end device 412) and their identified upstream peer end devices (here, the first end device 402). The third relay device 408 may receive the LMN message originated from the first relay device 404, via the fourth relay device 410. The third relay device 408 may transmit the LMN message to a sub-list of identified downstream end devices received in the LMN message from the fourth relay device 410 per next hop (here, the second end device 412).

The fourth relay device 410 (alternative U2U relay) may receive the LER message and/or the LMR message from the first relay device 404, which may include information of the list of identified downstream end devices (here, the second end device 412) and the list of identified upstream end devices (here, the first end device 402) originally routed through the failure link. The fourth relay device 410 may transmit the LER message and/or the LMR message targeting the list of identified downstream end devices (here, the second end device 412) received in the LER message and/or the LMR message from the first relay device 404, which may include information of the list of identified upstream end devices (here, the first end device 402) received in the LER message and/or the LMR message from the first relay device 404. The fourth relay device 410 may respond to the security establishment with the third relay device 408 after the LER message. The fourth relay device 410 may receive the LEA message and/or the LMA message from the third relay device 408, which may include information of a list of identified downstream end devices (here, the second end device 412) and a list of identified upstream end devices (here, the first end device 402) that are routable by the third relay device 408. The fourth relay device 410 may establish security with the first relay device 404 if the PC5 connection between the fourth relay device 410 and the first relay device 404 has not been established. The fourth relay device 410 may determine the list of QoS information sets between the first relay device 404 and the third relay device 408, for the list of identified downstream end devices (here, the second end device 412) and their identified upstream peer end devices (here, the first end device 402). The fourth relay device 410 may determine the list of QoS information sets between the first relay device 404 and the fourth relay device 410 and the list of QoS information sets between the fourth relay device 410 and the third relay device 408, for the list of identified downstream end devices (here, the second end device 412) and their identified upstream peer end devices (here, the first end device 402). The fourth relay device 410 may transmit the LMR message to the third relay device 408 for QoS flow setup and/or modification, which may include the list of QoS information sets between the fourth relay device 410 and the third relay device 408 for the list of identified downstream end devices (here, the second end device 412) and their identified upstream peer end devices (here, the first end device 402). The fourth relay device 410 may receive the LMA message from the third relay device 408 for QoS flow setup and/or modification between the fourth relay device 410 and the third relay device 408. The fourth relay device 410 may transmit the LEA message and/or the LMA message to the first relay device 404, which may include information of the list of identified downstream end devices (here, the second end device 412) and the list of identified upstream end devices (here, the first end device 402) received in the LEA message and/or the LMA message from the third relay device 408, the list of QoS information sets between the first relay device 404 and the fourth relay device 410 for the list of identified downstream end devices (here, the second end device 412) and their identified upstream peer end devices (here, the first end device 402). The fourth relay device 410 may receive the LMN message from the first relay device 404. The fourth relay device 410 may transmit the LMN message to the list of identified downstream end devices received in the LMN message from the first relay device 404 (here, the second end device 412, via the third relay device 408).

The second end device 412 (downstream end device) may receive the LMN message originated from the first relay device 404, via the third relay device 408. The second end device 412 may exchange traffic with the first end device 402 via the newly selected route between the first end device 402 and the second end device 412.

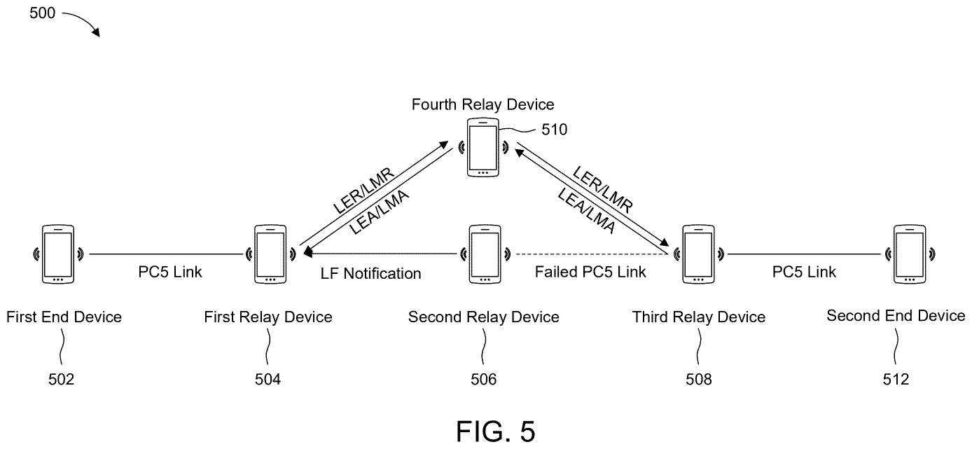

Referring now to FIG. 5, a communication system 500 illustrating an example configuration for reselection with integrated discovery between a precursor U2U relay and a next-hopU2U relay is shown according to one or more embodiments. The communication system 500 may include a first end device 502, a first relay device 504, a second relay device 506, a third relay device 508, a fourth relay device 510, and a second end device 512. Examples of the first end device 502, the first relay device 504, the second relay device 506, the third relay device 508, the fourth relay device 510, and the second end device 512 include but are not limited to one or more WTRUs, 5G ProSe enabled WTRUs, and/or D2D enabled WTRUs etc. Further, the first end device 502, the first relay device 504, the second relay device 506, the third relay device 508, the fourth relay device 510, and the second end device 512 may include but are not limited to one or more devices in vehicles and/or carried by pedestrians, one or more network devices and/or infrastructure devices etc.

The second relay device 506 may detect a link failure in a first link between the second relay device 506 and the third relay device 508 and may notify precursors (here, the first relay device 504) of one or more downstream end devices the information of its peer U2U relay of the failure link (here, the third relay device 508). The notified precursors (here, the first relay device 504) may perform a local integrated discovery targeting the third relay device 508. After alternative connection setup between the first relay device 504 and the third relay device 508 (here, via the fourth relay device 510), the first relay device 504 may notify one or more upstream end devices (here, the first end device 502) and one or more downstream end devices originally routed through the failure link (here, the second end device 512).

The first end device 502 (upstream end device) may receive the LMN message from the first relay device 504. The first end device 502 may exchange traffic with the second end device 512 via the newly selected route between the first end device 502 and the second end device 512.

The first relay device 504 (initiating U2U relay) may receive a LFN message from the second relay device 506, which may include information of its peer U2U relay of the failure link (here, the third relay device 508), information of the list of identified upstream end devices (here, the first end device 502) and the list of identified downstream end devices (here, the second end device 512) originally routed through the failure link. The first relay device 504 may determine the list of QoS information sets of the first relay device 504 for the list of identified downstream end devices (here, the second end device 512) received in the LFN message and their identified upstream peer end devices (here, the first end device 502). The first relay device 504 may transmit the LER message and/or the LMR message targeting the third relay device 508, which may include information of the list of identified downstream end devices (here, the second end device 512) and the list of identified upstream end devices (here, the first end device 502) received in the LFN message from the second relay device 506. The first relay device 504 may respond to the security establishment with the fourth relay device 510 after the LER message. The first relay device 504 may provide the list of QoS information sets of the first relay device 504 for the list of identified downstream end devices (here, the second end device 512) and their identified upstream peer end devices (here, the first end device 502) to the fourth relay device 510 in the security procedure after the LER message and/or in the LMR message.

The first relay device 504 may receive the LEA message and/or the LMA message from the fourth relay device 510, which may include information of a list of identified downstream end devices (here, the second end device 512) and the list of identified upstream end devices (here, the first end device 502) that are routable by the third relay device 508. The first relay device 504 may transmit the LMN message to a sub-list of identified upstream end devices received in the LEA message and/or the LMA message from the fourth relay device 510 (here, the first end device 502), per next hop. The first relay device 504 may transmit the LMN message to the list of identified downstream end devices received in the LEA message and/or the LMA message from the fourth relay device 510 (here, the second end device 512), via the fourth relay device 510.

The second relay device 506 (detecting U2U relay) may detect the link failure between the second relay device 506 and the third relay device 508. The second relay device 506 may determine the list of downstream end devices whose next hop is the third relay device 508 (here, the second end device 512) and the corresponding precursor (here, the first relay device 504) for each downstream end device (here, the second end device 512). The second relay device 506 may determine the list of upstream end devices (here, the first end device 502) whose next hop is the considered precursor (here, the first relay device 504) of downstream end devices (here, the second end device 512), and whose precursor is the third relay device 508, for each precursor of downstream end devices. The second relay device 506 may transmit the LFN message to each precursor of downstream end devices (here, the first relay device 504) whose next hop is the third relay device 508, which may include information of a list of identified downstream end devices (whose next hop is the third relay device 508 and whose precursor is the target precursor) and the list of identified upstream end devices (whose next hop is the considered precursor and whose precursor is the third relay device 508), and the failure link peer relay of the second relay device 506 (here, the third relay device 508).

The third relay device 508 (responding U2U relay) may receive the LER message and/or the LMR message from the fourth relay device 510, which may include information of the list of identified downstream end devices (here, the second end device 512) and the list of identified upstream end devices (here, the first end device 502) originally routed through the failure link. The second relay device 506 may establish security with the fourth relay device 510 if the PC5 connection between the third relay device 508 and the fourth relay device 510 has not been established. The second relay device 506 may transmit the LEA message and/or the LMA message to the fourth relay device 510, which may include information of the list of identified downstream end devices (here, the second end device 512) and the list of identified upstream end devices (here, the first end device 502) that are routable by the third relay device 508, the list of QoS information sets of the third relay device 508 for the list of identified downstream end devices (here, the second end device 512) and their identified upstream peer end devices (here, the first end device 502). The third relay device 508 may receive the LMR message from the fourth relay device 510 for QoS flow setup and/or modification between the fourth relay device 510 and the third relay device 508. The third relay device 508 may transmit the LMA message to the fourth relay device 510 for QoS flow setup and/or modification, which may include the list of QoS information sets between the fourth relay device 510 and the third relay device 508 for the list of identified downstream end devices (here, the second end device 512) and their identified upstream peer end devices (here, the first end device 502). The third relay device 508 may receive the LMN message originated from the first relay device 504, via the fourth relay device 510. The third relay device 508 may transmit the LMN message to the sub-list of identified downstream end devices received in the LMN message from the fourth relay device 510 per next hop (here, the second end device 512).

The fourth relay device 510 (alternative U2U relay) may receive the LER message and/or the LMR message from the first relay device 504, may include a list of identified downstream end devices (here, the second end device 512) and a list of identified upstream end devices (here, the first end device 502) originally routed through the failure link. The fourth relay device 510 may transmit the LER message and/or the LMR message targeting the third relay device 508, which may include information of a list of identified downstream end devices (here, the second end device 512) and a list of identified upstream end devices (here, the first end device 502) received in the LER message and/or the LMR message from the first relay device 504. The fourth relay device 510 may respond to the security establishment with the third relay device 508 after the LER message. The fourth relay device 510 may receive the LEA message and/or the LMA message from the third relay device 508, which may include information of a list of identified downstream end devices (here, the second end device 512) and the list of identified upstream end devices (here, the first end device 502) that are routable by the third relay device 508. The fourth relay device 510 may establish security with the first relay device 504 if the PC5 connection between the fourth relay device 510 and the first relay device 504 has not been established. The fourth relay device 510 may determine the list of QoS information sets between the first relay device 504 and the third relay device 508 for the list of identified downstream end devices (here, the second end device 512) and their identified upstream peer end devices (here, the first end device 502). The fourth relay device 510 may determine the list of QoS information sets between the first relay device 504 and the fourth relay device 510 and the list of QoS information sets between the fourth relay device 510 and the third relay device 508, for the list of identified downstream end devices (here, the second end device 512) and their identified upstream peer end devices (here, the first end device 502). The fourth relay device 510 may transmit the LMR message to the third relay device 508 for QoS flow setup and/or modification, which may include the list of QoS information sets between the fourth relay device 510 and the third relay device 508 for the list of identified downstream end devices (here, the second end device 512) and their identified upstream peer end devices (here, the first end device 502). The fourth relay device 510 may receive the LMA message from the third relay device 508 for QoS flow setup and/or modification between the fourth relay device 510 and the third relay device 508. The fourth relay device 510 may transmit the LEA message and/or the LMA message to the first relay device 504, which may include information of the list of identified downstream end devices (here, the second end device 512) and the list of identified upstream end devices (here, the first end device 502) received in the LEA message and/or the LMA message from the third relay device 508, the list of QoS information sets between the first relay device 504 and the fourth relay device 510 for the list of identified downstream end devices (here, the second end device 512) and their identified upstream peer end devices (here, the first end device 502). The fourth relay device 510 may receive the LMN message from the first relay device 504. The fourth relay device 510 may transmit the LMN message to a list of identified downstream end devices received in the LMN message from the first relay device 504 (here, the second end device 512, via the third relay device 508).

The second end device 512 (downstream end device) may receive the LMN message originated from the first relay device 504, via the third relay device 508. The second end device 512 may exchange traffic with the first end device 502 via the newly selected route between the first end device 502 and the second end device 512.

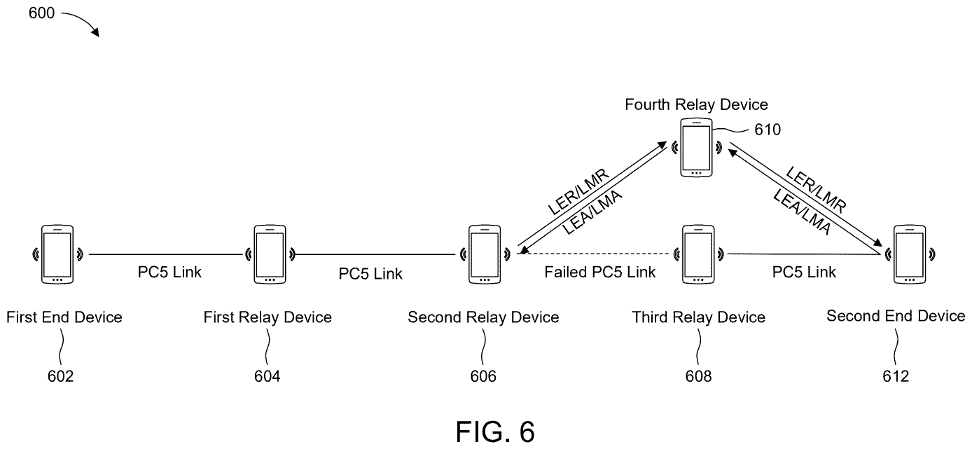

Referring now to FIG. 6, a communication system 600 illustrating an example configuration for reselection with integrated discovery between a precursor U2U relay and a next-hopU2U relay is shown according to one or more embodiments. The communication system 600 may include a first end device 602, a first relay device 604, a second relay device 606, a third relay device 608, a fourth relay device 610, and a second end device 612. Examples of the first end device 602, the first relay device 604, the second relay device 606, the third relay device 608, the fourth relay device 610, and the second end device 612 include but are not limited to one or more WTRUs, 5G ProSe enabled WTRUs, and/or D2D enabled WTRUs etc. Further, the first end device 602, the first relay device 604, the second relay device 606, the third relay device 608, the fourth relay device 610, and the second end device 612 may include but are not limited to one or more devices in vehicles and/or carried by pedestrians, one or more network devices and/or infrastructure devices etc.

The second relay device 606 may detect a link failure between the second relay device 606 and the third relay device 608. The second relay device 606 may perform a local integrated discovery targeting one or more downstream end devices originally routed through the failure link (here, the second end device 612). After alternative connection setup between the second relay device 606 and the second end device 612 (here, via the fourth relay device 610), the second relay device 606 may notify the upstream peer end devices of the second end device 612 originally routed from the failure link (here, the first end device 602).

The first end device 602 (peer end device) may receive a LMN message originated from the second relay device 606, via the first relay device 604. The first end device 602 may exchange traffic with the second end device 612 via the newly selected route between the first end device 602 and the second end device 612.

The first relay device 604 (U2U relay) may receive the LMN message from the second relay device 606. The first relay device 604 may transmit the LMN message to a sub-list of identified peer end devices of the second end device 612 received in the LMN message from the second relay device 606, per next hop (here, the first end device 602).

The second relay device 606 (detecting and initiating U2U relay) may detect a link failure between the second relay device 606 and the third relay device 608. The second relay device 606 may determine the list of upstream end devices whose precursor is the third relay device 608 (here, the first end device 602), the list of downstream end devices whose next hop is the third relay device 608 (here, the second end device 612). The second relay device 606 may determine the list of QoS information sets for the second relay device 606 for the list of identified downstream end devices (here, the second end device 612) and their identified upstream peer end devices (here, the first end device 602). The second relay device 606 may transmit the LER message and/or the LMR message, targeting the list of identified downstream end devices originally routed through the failure link (here, the second end device 612), which may include information of the list of identified upstream end devices originally routed through the failure link (here, the first end device 602). The second relay device 606 may respond to the security establishment with the fourth relay device 610 after the LER message. The second relay device 606 may provide the list of the QoS information sets of the second relay device 606 for the list of identified downstream end devices (here, the second end device 612) and their identified upstream peer end devices (here, the first end device 602) to the fourth relay device 610 in the security procedure after the LER message and/or in the LMR message. The second relay device 606 may receive the LEA message and/or the LMA message from the fourth relay device 610, which may include information of the second end device 612 and a list of identified peer end devices of the second end device 612 (here, the first end device 602). The second relay device 606 may transmit the LMN message to the second end device 612 via the fourth relay device 610. The second relay device 606 may transmit the LMN message to a sub-list of identified peer end devices of the second end device 612 received in the LEA message and/or the LMA message from the fourth relay device 610, per next hop (here, the first end device 602, via the first relay device 604).

The fourth relay device 610 (alternative U2U relay device) may receive the LER message and/or the LMR message from the second relay device 606, which may include information of the list of identified downstream end devices (here, the second end device 612) and the list of identified upstream end devices (here, the first end device 602) originally routed through the failure link. The fourth relay device 610 may transmit the LER message and/or the LMR message targeting the list of identified downstream end devices (here, the second end device 612) received in the LER message and/or the LMR message from the second relay device 606, which may include information of the list of identified upstream end devices (here, the first end device 602) received in the LER message and/or the LMR message from the second relay device 606. The fourth relay device 610 may respond to the security establishment with the second end device 612 after the LER message. The fourth relay device 610 may receive the LEA message and/or the LMA message from the second end device 612, which may include information of the second end device 612 and the list of identified peer end devices of the second end device 612 (here, the first end device 602). The fourth relay device 610 may establish security with the second relay device 606 if the PC5 connection between the fourth relay device 610 and the second relay device 606 has not been established. The fourth relay device 610 may determine the QoS information set between the second relay device 606 and the second end device 612, associated with the identified peer end devices of the second end device 612 (here, the first end device 602). The fourth relay device 610 may determine the QoS information set between the second relay device 606 and the fourth relay device 610 and the QoS information set between the fourth relay device 610 and the second end device 612, for the second end device 612 and the identified peer end devices of the second end device 612 (here, the first end device 602). The fourth relay device 610 may transmit the LMR message to the second end device 612 for QoS flow setup and/or modification, which may include QoS information set between the fourth relay device 610 and the second end device 612, associated with the identified peer end devices of the second end device 612 (here, the first end device 602). The fourth relay device 610 may receive the LMA message from the second end device 612 for QoS flow setup and/or modification between the fourth relay device 610 and the second end device 612. The fourth relay device 610 may transmit the LEA message and/or the LMA message to the second relay device 606, which may include information of the second end device 612 and the list of identified peer end devices of the second end device 612 (here, the first end device 602) received from the second end device 612, the QoS information set between the second relay device 606 and the fourth relay device 610 for the second end device 612 and the identified peer end devices of the second end device 612 (here, the first end device 602). The fourth relay device 610 may receive the LMN message from the second relay device 606. The fourth relay device 610 may transmit the LMN message to the list of identified downstream end devices received in the LMN message from the second relay device 606 (here, the second end device 612).

The second end device 612 (responding end device) may receive the LER message and/or the LMR message from the fourth relay device 610, which may include information of the second end device 612 and the list of identified downstream end devices (here, the second end device 612) and the list of identified upstream end devices (here, the first end device 602) originally routed through the failure link. The second end device 612 may establish security with the fourth relay device 610 if the PC5 connection between the second end device 612 and the fourth relay device 610 has not been established. The second end device 612 may transmit the LEA message and/or the LMA message to the fourth relay device 610, which may include information of the second end device 612 and the list of identified peer end devices of the second end device 612 (here, the first end device 602) that are in the list of identified upstream end devices (here, the first end device 602) received in the LER message and/or the LMR message from the fourth relay device 610, the end-to-end QoS information set for the second end device 612 and the identified peer end devices of the second end device 612 (here, the first end device 602). The second end device 612 possibly may request a IP address from the fourth relay device 610. The second end device 612 may receive the LMR message from the fourth relay device 610 for the QoS flow setup and/or modification between the fourth relay device 610 and the second end device 612. The second end device 612 may transmit the LMA message to the fourth relay device 610 for the QoS flow setup and/or modification, which may include the QoS information set between the fourth relay device 610 and the second end device 612, associated with the identified peer end devices of the second end device 612 (here, the first end device 602). The second end device 612 may receive the LMN message originated from the second relay device 606, via the fourth relay device 610. The second end device 612 may exchange traffic with the first end device 602 via the newly selected route between the first end device 602 and the second end device 612.

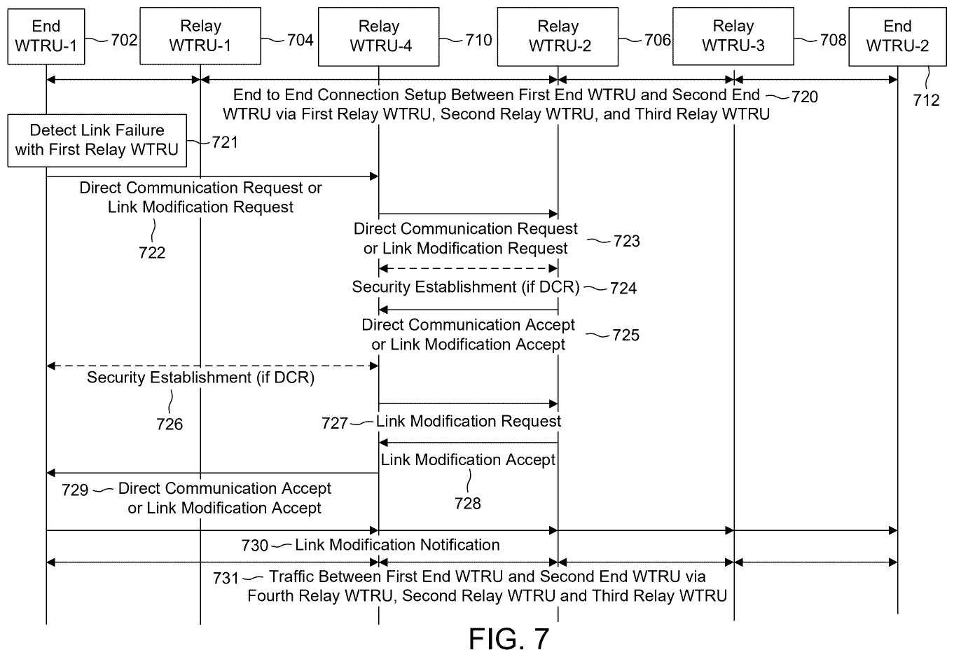

Referring now to FIG. 7, a call flow illustrating an example process for reselection with integrated discovery between an end WTRU and a responding U2U relay is shown according to one or more embodiments. The process may be performed by a first end WTRU 702, a first relay WTRU 704, a second relay WTRU 706, a third relay WTRU 708, a fourth relay WTRU 710, and a second end WTRU 712. Examples of the first end WTRU 702, the first relay WTRU 704, the second relay WTRU 706, the third relay WTRU 708, the fourth relay WTRU 710, and the second end WTRU 712 include but are not limited to one or more WTRUs, 5G ProSe enabled WTRUs, and/or D2D enabled WTRUs etc. Further, the first end WTRU 702, the first relay WTRU 704, the second relay WTRU 706, the third relay WTRU 708, the fourth relay WTRU 710, and the second end WTRU 712 may include but are not limited to one or more devices in vehicles and/or carried by pedestrians, one or more network devices and/or infrastructure devices etc.

In a WTRU-to-WTRU relay mesh network, a link failure may occur between an end WTRU and a neighbor U2U relay due to WTRU mobility and/or RF environmental changes. When this happens, it would be beneficial to have the option for the link failure detecting end WTRU (here, the first end WTRU 702) to perform local WTRU-to-WTRU relay reselection to circumvent the failure link without changing the remaining parts of the end-to-end routes with its peer end WTRUs originally routed through the failure link (here, the second end WTRU 712), before resorting to the end-to-end WTRU-to-WTRU relay reselection.

In various embodiments, the present disclosure provides a local WTRU-to-WTRU relay reselection procedure with integrated discovery to facilitate the link failure detecting end WTRU (here, the first end WTRU 702) to perform local integrated discovery with a responding U2U relay (here, the second relay WTRU 706) that knows an active route to any of its peer end WTRUs originally routed through the failure link (here, the second end WTRU 712).

At 720, the first end WTRU 702 and the second end WTRU 712 may set up hop-by-hop PC5 connections via the first relay WTRU 704, the second relay WTRU 706 and the third relay WTRU 708 for end-to-end communication, and the first end WTRU 702 and the second end WTRU 712 may exchange data traffic via the first relay WTRU 704, the second relay WTRU 706 and the third relay WTRU 708.

At 721, the first end WTRU 702 may detect link failure between the first end WTRU 702 and the first relay WTRU 704.

At 722, the first end WTRU 702 may transmit the DCR message and/or the LMR message targeting a list of peer end WTRUs that are routable by the first end WTRU 702 via the first relay WTRU 704 (here, the second end WTRU 712) in its unicast routing table, which may include information of the first end WTRU 702 and a list of identified peer end WTRUs. In the LMR message, information of a list of next hops (U2U relays and/or the peer end WTRUs of the first end WTRU 702) that are accessible by the first end WTRU 702 in direct PC5 connections may be included. In addition, in the LMR message, the first end WTRU 702 may provide end-to-end QoS information set for the first end WTRU 702 and the identified peer end WTRUs of the first end WTRU 702 (here, the second end WTRU 712), which includes, for end-to-end connections with the first end WTRU 702 being the source end WTRU during link establishment, the end-to-end QoS information between the first end WTRU 702 and each of the identified peer target end WTRUs of the first end WTRU 702 (here, the second end WTRU 712). Further, for end-to-end connections with the first end WTRU 702 being the target end WTRU during link establishment, the end-to-end QoS information=NA between the first end WTRU 702 and each of the identified peer source end WTRUs of the first end WTRU 702 (here, the first end WTRU 702). The fourth relay WTRU 710 may receive the DCR message and/or the LMR message from the first end WTRU 702 and may add a route entry to the first end WTRU 702 in its unicast routing table.

At 723, the fourth relay WTRU 710 may transmit the DCR message and/or the LMR message targeting the list of peer end WTRUs of the first end WTRU 702 (here, the second end WTRU 712) in the received the DCR message and/or the LMR message from the first end WTRU 702, which may include information of the first end WTRU 702 and the list of identified peer end WTRUs of the first end WTRU 702. In the LMR message, information of the list of next hops (U2U relays and/or the peer end WTRUs of the first end WTRU 702) that already have direct PC5 connections with the fourth relay WTRU 710 may be included.

The second relay WTRU 706 may receive the DCR message and/or the LMR message from the fourth relay WTRU 710 and may add a route entry to the first end WTRU 702 in its unicast routing table, with the fourth relay WTRU 710 as next hop.

At 724, if a U2U relay (here, the second relay WTRU 706) has one or more routes to one or more of the target peer end WTRUs of the first end WTRU 702 (here, the second end WTRU 712) in its unicast routing table, the second relay WTRU 706 may establish security with the fourth relay WTRU 710 if the PC5 connection between the second relay WTRU 706 and the fourth relay WTRU 710 has not been established. After security establishment with the fourth relay WTRU 710, the second relay WTRU 706 may update the route entry (e.g., next hop destination layer-2 id) to the first end WTRU 702 in its unicast routing table.

At 725, the second relay WTRU 706 (responding U2U relay) may transmit the DCA message and/or the LMA message to the fourth relay WTRU 710, which may include information of responding U2U relay (here, the second relay WTRU 706), information of the first end WTRU 702 and the list of the peer end WTRUs of the first end WTRU 702 in the received the DCR message and/or the LMR message that are routable by the second relay WTRU 706, the QoS information set of the second relay WTRU 706 for the first end WTRU 702 and the identified peer end WTRUs the first end WTRU 702 (here, the second end WTRU 712), which includes, for end-to-end connections with the first end WTRU 702 being the source end WTRU in the QoS context of unicast routing table of the second relay WTRU 706, the QoS information between the second relay WTRU 706 and each of the peer target end WTRUs the first end WTRU 702 in the list of identified peer end WTRUs of the first end WTRU 702 included in the DCA message and/or the LMA message (here, the second end WTRU 712), based on the information in the QoS context. For end-to-end connections with the first end WTRU 702 being the target end WTRU in the QoS context of the unicast routing table of the second relay WTRU 706, the QoS information between the second relay WTRU 706 and the first end WTRU 702 associated with each of the peer source end WTRUs of the first end WTRU 702 included in the list of identified peer end WTRUs of the first end WTRU 702 included in the DCA message and/or the LMA message (here, the second end WTRU 712), based on the information in the QoS context. The fourth relay WTRU 710 may receive the DCA message and/or the LMA message from the second relay WTRU 706 and may add a route entry to each of the peer end WTRUs of the first end WTRU 702 in the list of the identified peer end WTRUs of the first end WTRU 702 (here, the second end WTRU 712) received from the second relay WTRU 706 in its unicast routing table with the second relay WTRU 706 as the next hop. In addition, the fourth relay WTRU 710 may record the second relay WTRU 706 as the precursor to the first end WTRU 702 in its unicast routing table.

At 726, the fourth relay WTRU 710 may establish security with the first end WTRU 702 if the PC5 connection between the fourth relay WTRU 710 and the first end WTRU 702 has not been established. In the security procedure, the first end WTRU 702 may provide end-to-end QoS information set for the first end WTRU 702 and the identified peer end WTRUs of the first end WTRU 702 (here, the second end WTRU 712) to the fourth relay WTRU 710. After security establishment with the first end WTRU 702, the fourth relay WTRU 710 may update the route entry (e.g., next hop destination Layer 2 ID) to the first end WTRU 702 in its unicast routing table. The fourth relay WTRU 710 may determine the QoS information set between the first end WTRU 702 and the second relay WTRU 706 associated with the identified peer end WTRUs of the first end WTRU 702 (here, the second end WTRU 712), for end-to-end connections with the first end WTRU 702 being the source end WTRU during link establishment, the fourth relay WTRU 710 may determine the QoS information between the first end WTRU 702 and the second relay WTRU 706 based on the end-to-end QoS information associated with each of the identified peer end WTRUs of the first end WTRU 702 as received in the end-to-end QoS information set from the first end WTRU 702 and the QoS information between the second relay WTRU 706 and each of the identified peer target end WTRU of the first end WTRU 702 as received in the QoS information set from the second relay WTRU 706. Further, for end-to-end connections with the first end WTRU 702 being the target end WTRU during link establishment, the fourth relay WTRU 710 may determine the QoS information between the first end WTRU 702 and the second relay WTRU 706 associated with each of the identified peer source end WTRUs of the first end WTRU 702 based on the information received in the QoS information set from the second relay WTRU 706. The fourth relay WTRU 710 may determine the QoS information set between the first end WTRU 702 and the fourth relay WTRU 710 and the QoS information set between the fourth relay WTRU 710 and the second relay WTRU 706 based on the QoS information set between the first end WTRU 702 and the second relay WTRU 706, for the first end WTRU 702 and the identified peer end WTRUs of the first end WTRU 702 (here, the second end WTRU 712).

At 727, the fourth relay WTRU 710 may transmit the LMR message to the second relay WTRU 706 for the QoS flow setup and/or modification, including QoS information set between the fourth relay WTRU 710 and the second relay WTRU 706 for the first end WTRU 702 and the identified peer end WTRUs of the first end WTRU 702 (here, the second end WTRU 712).

At 728, the second relay WTRU 706 may transmit the LMA message to the fourth relay WTRU 710 for QoS flow setup and/or modification, including QoS information set between the fourth relay WTRU 710 and the second relay WTRU 706 for the first end WTRU 702 and the identified peer end WTRUs of the first end WTRU 702 (here, the second end WTRU 712).

At 729, the fourth relay WTRU 710 may transmit the DCA message and/or the LMA message to the first end WTRU 702, which may include information of responding U2U relay (here, the second relay WTRU 706), information of the first end WTRU 702 and the list of identified peer end WTRUs of the first end WTRU 702 in the received the DCA message and/or the LMA message from the second relay WTRU 706, the QoS information set between the first end WTRU 702 and the fourth relay WTRU 710, considering the QoS information set between the fourth relay WTRU 710 and the second relay WTRU 706 received from the second relay WTRU 706, for the first end WTRU 702 and the identified peer end WTRUs of the first end WTRU 702 (here, the second end WTRU 712). The first end WTRU 702 may receive the DCA message and/or the LMA message from the fourth relay WTRU 710 and may update the route entry to each peer end WTRU in the list of identified peer end WTRUs of the first end WTRU 702 (here, the second end WTRU 712) received from the fourth relay WTRU 710 in its unicast routing table, with the fourth relay WTRU as the next hop. If there are multiple feasible routes to a peer end WTRU, the first end WTRU 702 may select a next hop to the peer end WTRU. After the PC5 connection setup with the fourth relay WTRU 710, the first end WTRU 702 may receive the IP address from the fourth relay WTRU 710 or assign link local IP address.

At 730, the first end WTRU 702 may transmit the LMN message, via the fourth relay WTRU 710, to its identified peer end WTRUs received in the DCA message and/or the LMA message from the fourth relay WTRU 710, which may include information of the first end WTRU 702 and the list of identified peer end WTRUs of the first end WTRU 702 (here, the second end WTRU 712), to facilitate updating of the route entries (e.g., hop counts) to the first end WTRU 702 along the paths to the identified peer end WTRUs of the first end WTRU 702. The LMN message may include the IP address of the first end WTRU 702. The fourth relay WTRU 710 may receive the LMN message from the first end WTRU 702 and may record the first end WTRU 702 as the precursor to each of identified peer end WTRUs of the first end WTRU 702 (here, the second end WTRU 712) in its unicast routing table. The second relay WTRU 706 may receive the LMN message from the fourth relay WTRU 710 and may record the fourth relay WTRU 710 as the precursor to each of identified peer end WTRUs of the first end WTRU 702 (here, the second end WTRU 712) in its unicast routing table. The LMN message may be further forwarded to each identified peer end WTRU based on the unicast routing table hop by hop. At each intermediate U2U relay, the received list of identified peer end WTRUs may be split into multiple sub-lists with each sub-list including identified peer end WTRUs associated with the same next-hop U2U relay and sent in a separate LMN message via the corresponding next-hop U2U relay.

At 731, after successful connection setup between the first end WTRU 702 and the second relay WTRU 706 (here, via the fourth relay WTRU 710) and notifications to the identified peer end WTRUs of the first end WTRU 702 (here, the second end WTRU 712), as well as any further Layer 3 or Layer 2 end-to-end QoS reconfiguration (as needed), the first end WTRU 702 and the second end WTRU 712 may transfer traffic via the newly selected route between the first end WTRU 702 and the second end WTRU 712 (here, [the first end WTRU 702, the fourth relay WTRU 710, the second relay WTRU 706, the third relay WTRU 708, the second end WTRU 712]).

In an embodiment, after receiving the DCR message and/or the LMR message from the first end WTRU 702 or a subsequent U2U relay, if a receiving U2U relay (excluding the first relay WTRU 704) does not have unicast routes to one or more of the peer end WTRUs of the first end WTRU 702 included in the received the DCR message and/or the LMR message, the receiving U2U relay may further send out a DCR message and/or a LMR message, including the list of the peer end WTRUs of the first end WTRU 702 that it does not have unicast routes.

If a receiving U2U relay (excluding the first relay WTRU 704) has a unicast route to one or more of the peer end WTRUs of the first end WTRU 702 (here, the second end WTRU 712) in the received the DCR message and/or the LMR message, the receiving U2U relay may respond with the DCA message and/or the LMA message to the first end WTRU 702 via the previous hop (if there are more than one, the responding U2U relay may select one previous hop to respond), including the list of the peer end WTRUs of the first end WTRU 702 that it has unicast routes.

It is also possible that none of the intermediate U2U relays have existing unicast routes to one or more of the peer end WTRUs of the first end WTRU 702, e.g., the second end WTRU 712. In this case, the second end WTRU 712 may eventually respond with the DCA message and/or the LMA message as long as any other alternative end-to-end route is feasible. In an example, the end-to-end integrated discovery may be used. In this regard, even if the first end WTRU 702 may not be connected to the second relay WTRU 706 via the first relay WTRU 704, the first end WTRU 702 may eventually be connected to all of its peer end WTRUs originally going through the second relay WTRU 706, as long as there are other feasible alternative end-to-end routes.

In an example, the procedure described in this embodiment may also be applied in a node failure scenario (e.g., the first relay WTRU 704 may be shut down and/or run out of battery), which may be detected by, e.g., the onset of link release procedure or by the missing of consecutive keep-alive messages.

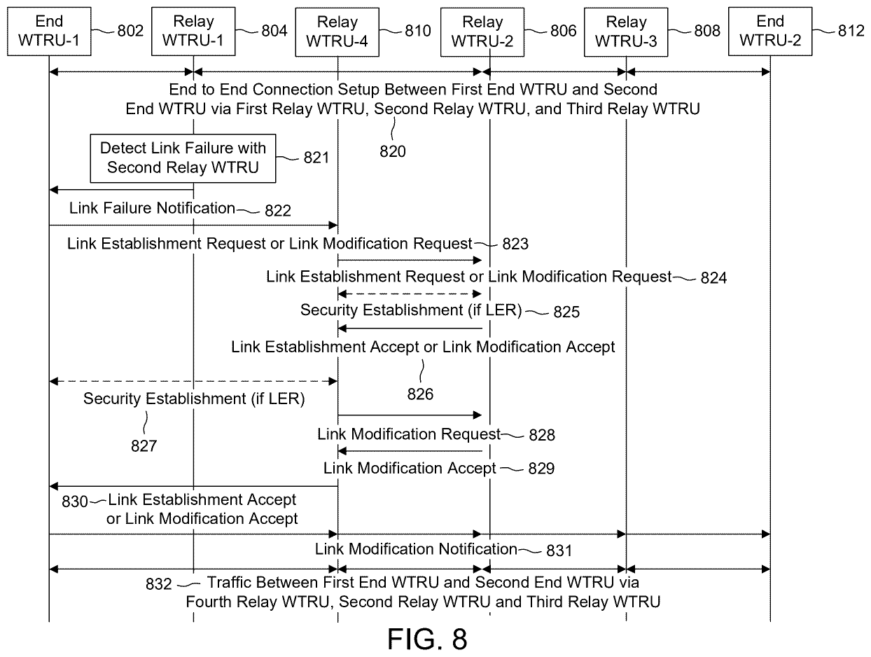

Referring now to FIG. 8, a call flow illustrating an example process for reselection with integrated discovery between an end WTRU and a failure link peer U2U relay is shown according to one or more embodiments. The process may be performed by a first end WTRU 802, a first relay WTRU 804, a second relay WTRU 806, a third relay WTRU 808, a fourth relay WTRU 810, and a second end WTRU 812. Examples of the first end WTRU 802, the first relay WTRU 804, the second relay WTRU 806, the third relay WTRU 808, the fourth relay WTRU 810, and the second end WTRU 812 include but are not limited to one or more WTRUs, 5G ProSe enabled WTRUs, and/or D2D enabled WTRUs etc. Further, the first end WTRU 802, the first relay WTRU 804, the second relay WTRU 806, the third relay WTRU 808, the fourth relay WTRU 810, and the second end WTRU 812 may include but are not limited to one or more devices in vehicles and/or carried by pedestrians, one or more network devices and/or infrastructure devices etc.

In a WTRU-to-WTRU relay mesh network, a link failure may occur between a pair of intermediate U2U relays due to WTRU mobility and/or RF environmental changes. When this happens, a link failure detecting U2U relay (here, the first relay WTRU 804) may notify the end WTRUs on the same side of the detecting U2U relay relative to the failure link (to be illustrated as upstream end WTRUs, here, the first end WTRU 802) of the link failure event. It would be beneficial to have the option for the notified end WTRUs to perform local WTRU-to-WTRU relay reselection to circumvent the failure link without changing the remaining parts of the end-to-end routes with their peer end WTRUs on the opposite side of the detecting U2U relay relative to the failure link (to be illustrated as downstream end WTRUs, here, the second end WTRU 812), before resorting to the end-to-end WTRU-to-WTRU relay reselection.

In various embodiments, the present disclosure provides a local WTRU-to-WTRU relay reselection procedure with integrated discovery to facilitate the notified end WTRU (here, the first end WTRU 802) to perform local integrated discovery with the failure link peer relay (here, the second relay WTRU 806).

At 820, the first end WTRU 802 and the second end WTRU 812 may set up hop-by-hop PC5 connections via the first relay WTRU 804, the second relay WTRU 806 and the third relay WTRU 808 for end-to-end communication, and the first end WTRU 802 and the second end WTRU 812 exchange data traffic via the first relay WTRU 804, the second relay WTRU 806 and the third relay WTRU 808.

At 821, the first relay WTRU 804 may detect the link failure between the first relay WTRU 804 and the second relay WTRU 806. The first relay WTRU 804 may find and/or determine, from its unicast routing table, a list of upstream end WTRUs whose precursor is the second relay WTRU 806 before the link failure (here, the first end WTRU 802) and a list of downstream end WTRUs whose next hop is the second relay WTRU 806 before link failure (here, the second end WTRU 812).

At 822, the first relay WTRU 804 may transmit a LFN message to each upstream end WTRU (here, the first end WTRU 802) in the list of identified upstream end WTRUs, which may include information of the list of identified upstream end WTRUs and the list of identified downstream end WTRUs, and the failure link peer relay of the first relay WTRU 804 (here, the second relay WTRU 806). If any identified upstream end WTRUs are not directly connected to the first relay WTRU 804, a LFN message may be forwarded to each identified upstream end WTRU based on the unicast routing table hop by hop. At each intermediate U2U relay, the received list of identified upstream end WTRUs may be split into multiple sub-lists with each sub-list including identified upstream end WTRUs associated with the same next hop and a sub-list of identified downstream end WTRUs with this next hop as the precursor, and sent in a separate link failure notification message via the corresponding next hop.

At 823, the first end WTRU 802 may transmit the LER message and/or the LMR message targeting the second relay WTRU 806, which may include information of target U2U relay (here, the second relay WTRU 806), information of the first end WTRU 802 and the list of identified peer end WTRUs that are in the list of downstream end WTRUs received in the LFN message from the first relay WTRU 804 (here, the second end WTRU 812). In the LMR message, information of the list of next hops (U2U relays and/or the peer end WTRUs of the first end WTRU 802) that already have direct PC5 connections with the first end WTRU 802 may be included. In addition, the first end WTRU 802 may provide end-to-end QoS information set for the first end WTRU 802 and the identified peer end WTRUs of the first end WTRU 802 (here, the second end WTRU 812), which includes for end-to-end connections with the first end WTRU 802 being the source end WTRU during link establishment, the end-to-end QoS information between the first end WTRU 802 and each of the identified peer target end WTRUs of the first end WTRU 802 (here, the second end WTRU 812). Further, for end-to-end connections with the first end WTRU 802 being the target end WTRU during link establishment, the end-to-end QoS info=NA between the first end WTRU 802 and each of the identified peer source end WTRUs of the first end WTRU 802 (here, the first end WTRU 802).

At 824, the fourth relay WTRU 810 may receive the LER message and/or the LMR message from the first end WTRU 802 and may add a route entry to the first end WTRU 802 in its unicast routing table. The fourth relay WTRU 810 may transmit the LER message and/or the LMR message targeting the second relay WTRU 806, which may include information of target U2U relay (here, the second relay WTRU 806), information of the first end WTRU 802 and the list of identified peer end WTRUs of the first end WTRU 802 received from the first end WTRU 802. In the LMR message, information of a list of next hops (U2U relays and/or the peer end WTRUs of the first end WTRU 802) that already have direct PC5 connections with the fourth relay WTRU 810 may be included. The second relay WTRU 806 may receive the LER message and/or the LMR message from the fourth relay WTRU 810 and may add a route entry to the first end WTRU 802 in its unicast routing table, with the fourth relay WTRU 810 as next hop.

At 825, the second relay WTRU 806 may establish security with the fourth relay WTRU 810 if the PC5 connection between the second relay WTRU 806 and the fourth relay WTRU 810 has not been established. After security establishment with the fourth relay WTRU 810, the second relay WTRU 806 may update the route entry (e.g., next hop destination Layer 2 ID) to the first end WTRU 802 in its unicast routing table.

At 826, the second relay WTRU 806 may transmit the LEA message and/or the LMA message to the fourth relay WTRU 810, which may include information of target U2U relay (here, the second relay WTRU 806), information of the first end WTRU 802 and the list of identified peer end WTRUs of the first end WTRU 802 received in the LER message and/or the LMR message from the fourth relay WTRU 810 that are routable via the second relay WTRU 806, the QoS information set of the second relay WTRU 806 for the first end WTRU 802 and the identified peer end WTRUs of the first end WTRU 802 (here, the second end WTRU 812), for end-to-end connections with the first end WTRU 802 being the source end WTRU in the QoS context of the unicast routing table of second relay WTRU 806, the QoS information between the second relay WTRU 806 and each of the peer target end WTRUs of the first end WTRU 802 included in the list of identified peer end WTRUs of the first end WTRU 802 included in the LEA message and/or the LMA message (here, the second end WTRU 812), based on the information in the QoS context. For end-to-end connections with the first end WTRU 802 being the target end WTRU in the QoS context of the unicast routing table of the second relay WTRU 806, the QoS information between the second relay WTRU 806 and the first end WTRU 802 associated with each of the peer source end WTRUs of the first end WTRU 802 included in the list of the identified peer end WTRUs of the first end WTRU 802 included in the LEA message and/or the LMA message (here, the second end WTRU 812), based on the information in the QoS context. The fourth relay WTRU 810 may receive the DCA message and/or the LMA message from the second relay WTRU 806 and may add the route entry to each peer end WTRU of the first end WTRU 802 in the list of identified peer end WTRUs of the first end WTRU 802 (here, the second end WTRU 812) received from the second relay WTRU 806 in its unicast routing table, with the second relay WTRU 806 as the next hop. In addition, the fourth relay WTRU 810 may record the second relay WTRU 806 as the precursor to the first end WTRU 802 in its unicast routing table.

At 827, the fourth relay WTRU 810 may establish security with the first end WTRU 802 if the PC5 connection between the fourth relay WTRU 810 and the first end WTRU 802 has not been established. In the security procedure, the first end WTRU 802 may provide end-to-end QoS information set for the first end WTRU 802 and the identified peer end WTRUs of the first end WTRU 802 (here, the second end WTRU 812) to the fourth relay WTRU 810. After security establishment with the first end WTRU 802, the fourth relay WTRU 810 may update the route entry (e.g., next hop destination Layer 2 ID) to the first end WTRU 802 in its unicast routing table. The fourth relay WTRU 810 may determine the QoS information set between the first end WTRU 802 and the second relay WTRU 806 associated with each of the identified peer end WTRUs of the first end WTRU 802 (here, the second end WTRU 812), for end-to-end connections with the first end WTRU 802 being the source end WTRU during link establishment, the fourth relay WTRU 810 may determine the QoS information between the first end WTRU 802 and the second relay WTRU 806 based on the end-to-end QoS information associated with each of the identified peer end WTRUs of the first end WTRU 802 as received in the end-to-end QoS information set from the first end WTRU 802 and the QoS information between the second relay WTRU 806 and each of the identified peer target end WTRU of the first end WTRU 802 as received in the QoS information set from the second relay WTRU 806. Further, for end-to-end connections with the first end WTRU 802 being the target end WTRU during link establishment, the fourth relay WTRU 810 may determine the QoS information between the first end WTRU 802 and the second relay WTRU 806 associated with each of the identified peer source end WTRUs of the first end WTRU 802 based on the information received in the QoS information set from the second relay WTRU 806. The fourth relay WTRU 810 may determine the QoS information set between the first end WTRU 802 and the fourth relay WTRU 810 and the QoS information set between the fourth relay WTRU 810 and the second relay WTRU 806 based on the QoS information set between the first end WTRU 802 and the second relay WTRU 806, for the first end WTRU 802 and the identified peer end WTRUs of the first end WTRU 802 (here, the second end WTRU 812).

At 828, the fourth relay WTRU 810 may transmit the LMR message to the second relay WTRU 806 for QoS flow setup and/or modification, including QoS information set between the fourth relay WTRU 810 and the second relay WTRU 806, for the first end WTRU 802 and the identified peer end WTRUs of the first end WTRU 802 (here, the second end WTRU 812).

At 829, the second relay WTRU 806 may transmit the LMA message to the fourth relay WTRU 810 for QoS flow setup and/or modification, including QoS information set between the fourth relay WTRU 810 and the second relay WTRU 806, for the first end WTRU 802 and the identified peer end WTRUs of the first end WTRU 802 (here, the second end WTRU 812).

At 830, the fourth relay WTRU 810 may transmit the LEA message and/or the LMA message to the first end WTRU 802, which may include information of target U2U relay (here, the second relay WTRU 806), information of the first end WTRU 802 and a list of identified peer end WTRUs of the first end WTRU 802 in the received the DCA message and/or the LMA message from the second relay WTRU 806, the QoS information set between the first end WTRU 802 and the fourth relay WTRU 810, considering the QoS information set between the fourth relay WTRU 810 and the second relay WTRU 806 received from the second relay WTRU 806, for the first end WTRU 802 and the identified peer end WTRUs of the first end WTRU 802 (here, the second end WTRU 812). The first end WTRU 802 may receive the LEA message and/or the LMA message from the fourth relay WTRU 810 and may update the route entry to each peer end WTRU in the list of identified peer end WTRUs (here, the second end WTRU 812) received from the fourth relay WTRU 810 in its unicast routing table, with the fourth relay WTRU 810 as next hop. After the PC5 connection setup with the fourth relay WTRU 810, the first end WTRU 802 may receive the IP address from the fourth relay WTRU 810 and/or assign link local IP address.

At 831, the first end WTRU 802 may transmit the LMN message, via the fourth relay WTRU 810, to its identified peer end WTRUs received in the LEA message and/or the LMA message from the fourth relay WTRU 810, which may include information of the first end WTRU 802 and the list of identified peer end WTRU the first end WTRU 802 (here, the second end WTRU 812), to facilitate updating of route entries (e.g., hop counts) to the first end WTRU 802 along the paths to the identified peer end WTRUs of the first end WTRU 802. The LMN message may include the IP address of the first end WTRU 802. The fourth relay WTRU 810 may receive the LMN message from the first end WTRU 802 and may record the first end WTRU 802 as the precursor to each of the peer end WTRUs of first end WTRU 802 in the list of identified peer end WTRUs of the first end WTRU 802 (here, the second end WTRU 812) in its unicast routing table. The second relay WTRU 806 may receive the LMN message from the fourth relay WTRU 810 and may record the fourth relay WTRU 810 as the precursor to each of the peer end WTRUs of the first end WTRU 802 in the list of identified peer end WTRUs of the first end WTRU 802 (here, the second end WTRU 812) in its unicast routing table.

The LMN message may be further forwarded to each identified peer end WTRU based on the unicast routing table hop by hop. At each intermediate U2U relay, the received list of identified peer end WTRUs may be split into multiple sub-lists with each sub-list including identified peer end WTRUs associated with the same next hop and transmitted in a separate LMN message via the corresponding next hop.

At 832, after successful connection setup between the first end WTRU 802 and the second relay WTRU 806 (here, via the fourth relay WTRU 810) and notifications to the identified peer end WTRUs of the first end WTRU 802 (here, the second end WTRU 812), as well as any further Layer 3 and/or Layer 2 end-to-end QoS reconfiguration (as needed), the first end WTRU 802 and the second end WTRU 812 may transfer traffic via the newly selected route between the first end WTRU 802 and the second end WTRU 812 (here, [the first end WTRU 802, the fourth relay WTRU 810, the second relay WTRU 806, the third relay WTRU 808, the second end WTRU 812]).

If the first end WTRU 802 does not receive the LEA message and/or the LMA message after transmitting the LER message and/or the LMR message targeting the second relay WTRU 806 for a preconfigured period of time, the first end WTRU 802 may transmit the DCR and/or the LMR message targeting a list of identified peer end WTRUs that are in the list of downstream end WTRUs received in the LFN from the first relay WTRU 804 (here, the second end WTRU 812). The remaining procedures may be performed similar to FIG. 7.

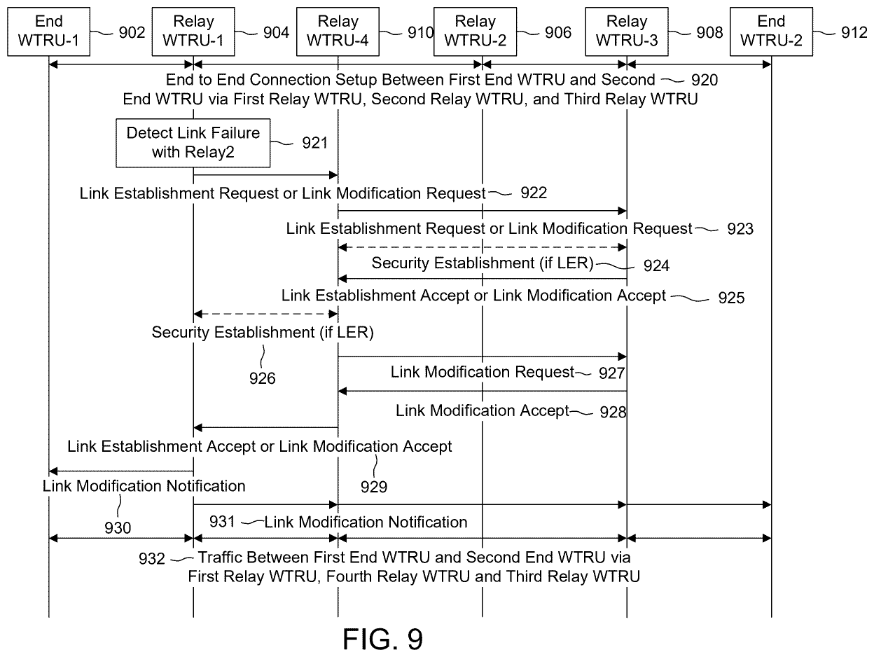

Referring now to FIG. 9, a call flow illustrating an example process for reselection with integrated discovery between an end WTRU and a failure link peer U2U relay is shown according to one or more embodiments. The process may be performed by a first end WTRU 902, a first relay WTRU 904, a second relay WTRU 906, a third relay WTRU 908, a fourth relay WTRU 910, and a second end WTRU 912. Examples of the first end WTRU 902, the first relay WTRU 904, the second relay WTRU 906, the third relay WTRU 908, the fourth relay WTRU 910, and the second end WTRU 912 include but are not limited to one or more WTRUs, 5G ProSe enabled WTRUs, and/or D2D enabled WTRUs etc. Further, the first end WTRU 902, the first relay WTRU 904, the second relay WTRU 906, the third relay WTRU 908, the fourth relay WTRU 910, and the second end WTRU 912 may include but are not limited to one or more devices in vehicles and/or carried by pedestrians, one or more network devices and/or infrastructure devices etc.

In a WTRU-to-WTRU relay mesh network, a link failure may occur between a pair of intermediate U2U relays due to WTRU mobility and/or RF environmental changes. When this happens, it would be beneficial to have the option for the link failure detecting U2U relay (here, the first relay WTRU 904) to perform local WTRU-to-WTRU relay reselection to circumvent the failure link without changing the remaining parts of the end-to-end routes between each pair of (upstream and downstream) end WTRUs originally routed through the failure link (here, the first end WTRU 902 and the second end WTRU 912), before resorting to the end-to-end WTRU-to-WTRU relay reselection.

In various embodiments, the present disclosure provides a local WTRU-to-WTRU relay reselection procedure with integrated discovery to facilitate the link failure detecting U2U relay (here, the first relay WTRU 904) to perform the local integrated discovery with a responding U2U relay (here, the third relay WTRU 908) that knows an active route to any of the end WTRUs on the opposite side of the detecting U2U relay relative to the failure link (to be illustrated as downstream end WTRUs, here, the second end WTRU 912).

At 920, the first end WTRU 902 and the second end WTRU 912 may set up hop-by-hop PC5 connections via the first relay WTRU 904, the second relay WTRU 906 and the third relay WTRU 908 for end-to-end communication, and the first end WTRU 902 and the second end WTRU 912 exchange data traffic via the first relay WTRU 904, the second relay WTRU 906 and the third relay WTRU 908.

At 921, the first relay WTRU 904 may detect the link failure between the first relay WTRU 904 and the second relay WTRU 906. The first relay WTRU 904 may determine, from its unicast routing table, the list of upstream end WTRUs whose precursor is the second relay WTRU 906 before the link failure (here, the first end WTRU 902) and the list of downstream end WTRUs whose next hop is the second relay WTRU 906 before link failure (here, the second end WTRU 912), the list of the QoS information sets of the first relay WTRU 904 for the list of identified downstream end WTRUs (here, the second end WTRU 912) and their identified upstream peer end WTRUs (here, the first end WTRU 902). The QoS information set of first relay WTRU 904 for the second end WTRU 912 and the identified peer end WTRUs of the second end WTRU 912 includes, for end-to-end connections with the second end WTRU 912 being the source end WTRU in the QoS context of the unicast routing table of first relay WTRU 904, the QoS information between the first relay WTRU 904 and each of peer target end WTRUs of the second end WTRU 912 that is in the list of identified upstream end WTRUs (here, the first end WTRU 902) based on the information in the QoS context. Further, for end-to-end connections with the second end WTRU 912 being the target end WTRU in the QoS context of the unicast routing table of first relay WTRU 904, the QoS information between the first relay WTRU 904 and the second end WTRU 912 associated with each of the peer source end WTRUs of the second end WTRU 912 that is in the list of identified upstream end WTRUs (here, the first end WTRU 902) based on the information in the QoS context.

At 922, the first relay WTRU 904 may transmit the LER message and/or the LMR message, targeting the list of identified downstream end WTRUs (here, the second end WTRU 912), which may include information of initiating U2U relay (here, the first relay WTRU 904), information of the list of identified downstream end WTRUs (here, the second end WTRU 912) and the list of identified upstream end WTRUs (here, the first end WTRU 902). In the LMR message, information of the list of next hops (U2U relays and/or downstream end WTRUs) that already have direct PC5 connections with the first relay WTRU 904 may be included. In addition, the first relay WTRU 904 may provide the list of the QoS information sets of the first relay WTRU 904 for the list of identified downstream end WTRUs (here, the second end WTRU 912) and their identified upstream peer end WTRUs (here, the first end WTRU 902).

At 923, the fourth relay WTRU 910 may transmit the LER message and/or the LMR message targeting the received list of identified downstream end WTRUs (here, the second end WTRU 912), which may include information of initiating U2U relay (here, the first relay WTRU 904), information of the list of identified downstream end WTRUs (here, the second end WTRU 912) and the list of identified upstream end WTRUs (here, the first end WTRU 902) received from the first relay WTRU 904. In the LMR message, information of the list of next hops (U2U relays and/or downstream end WTRUs) that already have direct PC5 connections with the fourth relay WTRU 910 may be included.

At 924, if a U2U relay (here, the third relay WTRU 908) has one or more routes to one or more of the identified downstream end WTRUs (here, the second end WTRU 912) received in the LER message and/or the LMR message from the fourth relay WTRU 910 in its unicast routing table, the third relay WTRU 908 may establish security with the fourth relay WTRU 910 if the PC5 connection between the third relay WTRU 908 and the fourth relay WTRU 910 has not been established.

At 925, the third relay WTRU 908 (responding U2U relay) may transmit the LEA message and/or the LMA message to the fourth relay WTRU 910, which may include information of initiating U2U relay (here, the first relay WTRU 904) and responding U2U relay (here, the third relay WTRU 908), information of the list of identified downstream end WTRUs (here, the second end WTRU 912) and the list of identified upstream end WTRUs (here, the first end WTRU 902) received in the LER message and/or the LMR message from the fourth relay WTRU 910 that are routable by the third relay WTRU 908, the list of the QoS information sets of third relay WTRU 908 for the list of identified downstream end WTRUs (here, the second end WTRU 912) and their identified upstream peer end WTRUs (here, the first end WTRU 902). In an example, the QoS information set of the third relay WTRU 908 for the second end WTRU 912 includes, for end-to-end connections with the second end WTRU 912 being the source end WTRU in the QoS context of the unicast routing table of the third relay WTRU 908, the QoS information between the third relay WTRU 908 and each of peer target end WTRUs of the second end WTRU 912 (here, the first end WTRU 902) that is in the list of identified upstream end WTRUs, based on the information in the QoS context. Further, for end-to-end connections with the second end WTRU 912 being the target end WTRU in the QoS context of the unicast routing table of the third relay WTRU 908, the QoS information between the third relay WTRU 908 and the second end WTRU 912 associated with each of the peer source end WTRUs of the second end WTRU 912 that is in the list of identified upstream end WTRUs (here, the first end WTRU 902), based on the information in the QoS context. The fourth relay WTRU 910 may receive the LEA message and/or the LMA message from the third relay WTRU 908 and may add a route entry to each downstream end WTRU in the received list of identified downstream WTRUs (here, the second end WTRU 912) from the third relay WTRU 908 in its unicast routing table, with the third relay WTRU 908 as next hop. In addition, the fourth relay WTRU 910 may record the third relay WTRU 908 as the precursor to the received list of identified upstream end WTRUs (here, the first end WTRU 902) in its unicast routing table.

At 926, the fourth relay WTRU 910 may establish security with the first relay WTRU 904 if the PC5 connection between the fourth relay WTRU 910 and the first relay WTRU 904 has not been established. In the security procedure, the first relay WTRU 904 may provide list of the QoS information sets of first relay WTRU 904 for the list of identified downstream end WTRUs (here, the second end WTRU 912) and their identified upstream peer end WTRUs (here, the first end WTRU 902) to the fourth relay WTRU 910.

The fourth relay WTRU 910 may determine the list of QoS information sets between the first relay WTRU 904 and the third relay WTRU 908 for the list of identified downstream end WTRUs (here, the second end WTRU 912) and their identified upstream peer end WTRUs (here, the first end WTRU 902). For example, the QoS information set between the first relay WTRU 904 and the third relay WTRU 908 for the second end WTRU 912 and the identified peer end WTRUs of the second end WTRU 912 (here, the first end WTRU 902) may be determined. In that, for end-to-end connections with the second end WTRU 912 being the source end WTRU during link establishment, the fourth relay WTRU 910 may determine the QoS information between the first relay WTRU 904 and the third relay WTRU 908 for the second end WTRU 912 and each of the identified peer target end WTRUs of the second end WTRU 912 (here, the first end WTRU 902) based on the QoS information the between the first relay WTRU 904 and peer target end WTRU of the second end WTRU 912 as received in the QoS information set from the first relay WTRU 904 and the QoS information between the third relay WTRU 908 and the peer target end WTRU of the second end WTRU 912 as received in the QoS information set from the third relay WTRU 908. Further, for end-to-end connections with the second end WTRU 912 being the target end WTRU during link establishment, the fourth relay WTRU 910 may determine the QoS information between the first relay WTRU 904 and the third relay WTRU 908 for the second end WTRU 912 and each of the identified peer target end WTRUs of the second end WTRU 912 (here, the first end WTRU 902), based on the QoS information between the first relay WTRU 904 and the second end WTRU 912 as received in the QoS information set from the first relay WTRU 904 and the QoS information between the third relay WTRU 908 and the second end WTRU 912 as received in the QoS information set from the third relay WTRU 908, associated with each of the peer source end WTRUs of the second end WTRU 912 (here, the first end WTRU 902).

The fourth relay WTRU 910 may determine the list of QoS information sets between the first relay WTRU 904 and the fourth relay WTRU 910 and the list of QoS information sets between the fourth relay WTRU 910 and the third relay WTRU 908 based on the list of QoS information sets between the first relay WTRU 904 and the third relay WTRU 908, for the list of identified downstream end WTRUs (here, the second end WTRU 912) and their identified upstream peer end WTRUs (here, the first end WTRU 902).

At 927, the fourth relay WTRU 910 may transmit the LMR message to the third relay WTRU 908 for QoS flow setup and/or modification, including the list of QoS information sets between the fourth relay WTRU 910 and the third relay WTRU 908 for the list of identified downstream end WTRUs (here, the second end WTRU 912) and their identified upstream peer end WTRUs (here, the first end WTRU 902). For example, the QoS information set for the second end WTRU 912 may include the QoS information between the fourth relay WTRU 910 and the third relay WTRU 908 for the second end WTRU 912 and each of the identified peer end WTRUs of the second end WTRU 912 (here, the first end WTRU 902).

At 928, the third relay WTRU 908 may transmit the LMA message to the fourth relay WTRU 910 for QoS flow setup and/or modification, including the list of QoS information sets between the fourth relay WTRU 910 and the third relay WTRU 908 for the list of identified downstream end WTRUs (here, the second end WTRU 912) and their identified upstream peer end WTRUs (here, the first end WTRU 902).

At 929, the fourth relay WTRU 910 may transmit the LEA message and/or the LMA message to the first relay WTRU 904. The LEA message and/or the LMA message may include information of initiating U2U relay (here, the first relay WTRU 904) and responding U2U relay (here, the third relay WTRU 908), information of the list of identified downstream end WTRUs (here, the second end WTRU 912) and the list of identified upstream end WTRUs (here, the first end WTRU 902) received in the LEA message and/or the LMA message from the third relay WTRU 908. The LEA message and/or the LMA message may include the list of QoS information sets between the first relay WTRU 904 and the fourth relay WTRU 910, considering the list of QoS information sets between the fourth relay WTRU 910 and the third relay WTRU 908 received from the third relay WTRU 908, for the list of identified downstream end WTRUs (here, the second end WTRU 912) and their identified upstream peer end WTRUs (here, the first end WTRU 902). In an example, the QoS information set between the first relay WTRU 904 and the fourth relay WTRU 910 for the second end WTRU 912 and the identified peer end WTRUs of the second end WTRU 912 includes the QoS information between the first relay WTRU 904 and the fourth relay WTRU 910, for the second end WTRU 912 and each of the identified peer end WTRUs of the second end WTRU 912 (here, the first end WTRU 902).

The first relay WTRU 904 may receive the LEA message and/or the LMA message from the fourth relay WTRU 910 and adds a route entry to each downstream end WTRU in the list of identified downstream WTRUs (here, the second end WTRU 912) in its unicast routing table, with the fourth relay WTRU 910 as next hop. In addition, the first relay WTRU 904 may record the fourth relay WTRU 910 as the precursor to each upstream end WTRU in the received list of identified upstream end WTRUs (here, the first end WTRU 902) from the fourth relay WTRU 910 in its unicast routing table.

At 930, the first relay WTRU 904 may transmit the LMN message to the list of identified upstream end WTRUs (here, the first end WTRU 902) received in the LEA message and/or the LMA message from the fourth relay WTRU 910, which may include information of the list of identified upstream end WTRUs (here, the first end WTRU 902) and the list of identified downstream end WTRUs (here, the second end WTRU 912) in the received the LEA message and/or the LMA message, to facilitate updating of route entries (e.g., hop counts) to the identified downstream end WTRUs along the upstream paths.

The LMN message may be forwarded to each identified upstream end WTRU based on the unicast routing table hop by hop. At each intermediate U2U relay, the received list of identified upstream end WTRUs may be split into multiple sub-lists with each sub-list including identified upstream end WTRUs associated with the same next hop and a sub-list of identified downstream end WTRUs with this next hop as the precursor, and sent in a separate link modification notification message via the corresponding next hop.

At 931, the first relay WTRU 904 may transmit the LMN message to the list of identified downstream end WTRUs (here, the second end WTRU 912) received in the LEA message and/or the LMA message from the fourth relay WTRU 910, which may include information of a list of identified downstream end WTRU (here, the second end WTRU 912) and the list of identified upstream end WTRUs in the received the LEA message and/or the LMA message, to facilitate updating of route entries (e.g., hop counts) to the identified upstream end WTRUs along the downstream paths. In addition, the fourth relay WTRU 910 may receive the LMN message from the first relay WTRU 904 and may add a route entry to each upstream end WTRU in the received list of identified upstream WTRUs (here, the second end WTRU 912) in its unicast routing table, with the first relay WTRU 904 as next hop. In addition, the fourth relay WTRU 910 records the first relay WTRU 904 as the precursor to each downstream end in the received list of identified downstream end WTRUs (here, the second end WTRU 912) in its unicast routing table.

The third relay WTRU 908 may receive the LMN message from the fourth relay WTRU 910 and may add the route entry to each upstream end WTRU in the received list of identified upstream WTRUs (here, the second end WTRU 912) in its unicast routing table, with the fourth relay WTRU 910 as next hop. In addition, the third relay WTRU 908 may record the fourth relay WTRU 910 as the precursor to each downstream end WTRU in the received list of identified downstream end WTRUs (here, the second end WTRU 912) in its unicast routing table.

The LMN message may be further forwarded to each identified downstream end WTRU based on the unicast routing table hop by hop. At each intermediate U2U relay, the received list of identified downstream end WTRUs may be split into multiple sub-lists with each sub-list including identified downstream end WTRUs associated with the same next hop and the sub-list of identified upstream end WTRUs with this next hop as the precursor, and sent in a separate LMN message via the corresponding next hop.

At 932, after successful connection setup between the first relay WTRU 904 and the third relay WTRU 908 (here, via the fourth relay WTRU 910) and notifications to the identified upstream end WTRUs (here, the first end WTRU 902) and downstream end WTRUs (here, the second end WTRU 912), as well as any further Layer 3 and/or Layer 2 end-to-end QoS reconfiguration (as needed), the first end WTRU 902 and the second end WTRU 912 may transfer traffic via the newly selected route between the first end WTRU 902 and the second end WTRU 912 (here, [the first end WTRU 902, the first relay WTRU 904, the fourth relay WTRU 910, the third relay WTRU 908, the second end WTRU 912]).

If any of the downstream end WTRUs still cannot be reached based on the received LEA message and/or the LMA message after the first relay WTRU 904 transmitted the LER message and/or the LMR message for a preconfigured period of time (for example, the second relay WTRU 906 may have multiple next hops (e.g., the third relay WTRU 908, the third relay WTRU 908′, the third relay WTRU 908″ . . . etc.), each associated with a different subset of downstream end WTRUs and the first relay WTRU 904 may receive the LEA message and/or the LMA message from the third relay WTRU 908′ and the third relay WTRU 908″ but not from the third relay WTRU 908,

The first relay WTRU 904 may transmit the LFN message to each precursor of the unreachable downstream end WTRUs (based on unicast routing table of the first relay WTRU 904), which may include information of the list of unreachable downstream end WTRUs (whose next hop is the second relay WTRU 906 and whose precursor is the target precursor) and the corresponding list of upstream end WTRUs (whose next hop is the considered precursor and whose precursor is the second relay WTRU 906).

If the receiving precursor of the first relay WTRU 904 is one of the included upstream end WTRUs, the receiving upstream end WTRU (here, the first end WTRU 902) may performs local and/or end-to-end integrated discovery with its peer end WTRUs that are in the received list of unreachable downstream end WTRUs (here, the second end WTRU 912) similar to FIG. 7.

If the receiving precursor of the first relay WTRU 904 acts as a U2U relay (in an example, a precursor may serve as both an end WTRU and a U2U relay), the receiving precursor further may transmit a LFN message to each of its own precursors of the received unreachable downstream end WTRUs (based on its own unicast routing table), which may include information of a sub-list of the unreachable downstream end WTRUs received from the first relay WTRU 904 and a corresponding sub-list of the received upstream end WTRUs (whose next hop is the considered precursor of the receiving the precursor of first relay WTRU 904 and whose precursor is the first relay WTRU 904). Alternatively, the receiving precursor acting as a U2U relay may perform local integrated discovery similar to FIG. 9 targeting the associated unreachable downstream end WTRUs before transmitting the LFN message further upstream. The notification process may continue until all the identified upstream end WTRUs are reached. Each notified upstream end WTRU may perform local and/or end-to-end integrated discovery with its peer end WTRUs that are in the received list of unreachable downstream end WTRUs similar to FIG. 7.

In an example, this process may also be applied in the node failure scenario (e.g., the second relay WTRU 906 may be shut down or run out of battery), which may be detected by the onset of link release procedure and/or by the missing of consecutive keep-alive messages.

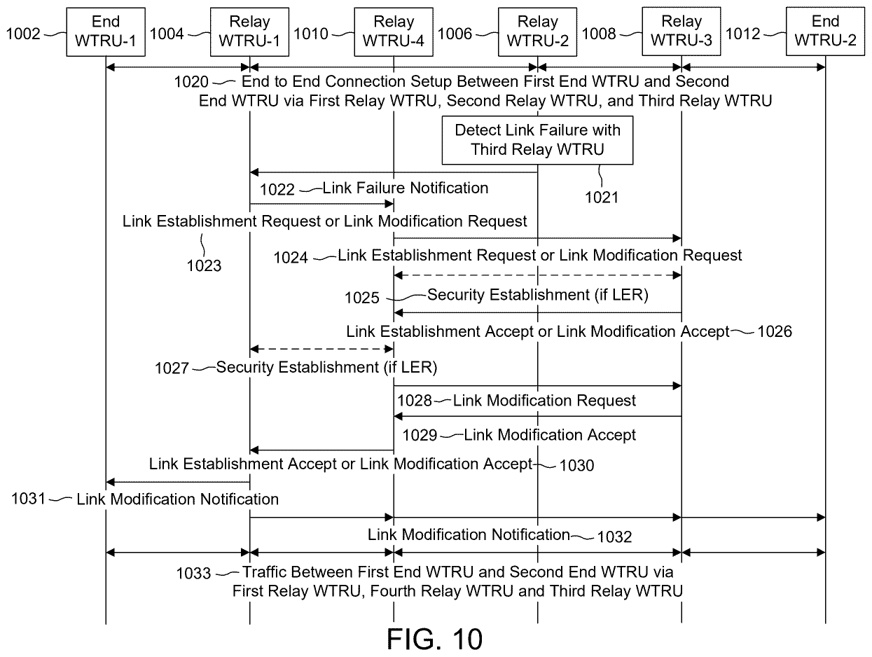

Referring now to FIG. 10, a call flow illustrating an example process for reselection with integrated discovery between a precursor U2U relay and a next hop U2U relay is shown according to one or more embodiments. The process may be performed by a first end WTRU 1002, a first relay WTRU 1004, a second relay WTRU 1006, a third relay WTRU 1008, a fourth relay WTRU 1010, and a second end WTRU 1012. Examples of the first end WTRU 1002, the first relay WTRU 1004, the second relay WTRU 1006, the third relay WTRU 1008, the fourth relay WTRU 1010, and the second end WTRU 1012 include but are not limited to one or more WTRUs, 5G ProSe enabled WTRUs, and/or D2D enabled WTRUs etc. Further, the first end WTRU 1002, the first relay WTRU 1004, the second relay WTRU 1006, the third relay WTRU 1008, the fourth relay WTRU 1010, and the second end WTRU 1012 may include but are not limited to one or more devices in vehicles and/or carried by pedestrians, one or more network devices and/or infrastructure devices etc.

In a WTRU-to-WTRU relay mesh network, a link failure may occur between a pair of intermediate U2U relays due to WTRU mobility and/or RF environmental changes. When this happens, the link failure detecting U2U relay (here, the second relay WTRU 1006) may notify the precursor U2U relay (here, the first relay WTRU 1004) associated with end WTRUs on the opposite side of the detecting U2U relay relative to the failure link (to be illustrated as downstream end WTRUs, here, the second end WTRU 1012) of the link failure event. It would be beneficial to have the option for the notified precursor U2U relay (here, the first relay WTRU 1004) to perform local WTRU-to-WTRU relay reselection to circumvent the failure link without changing the remaining parts of the end-to-end routes between each pair of (upstream and downstream) end WTRUs originally routed through the failure link (here, the first end WTRU 1002 and the second end WTRU 1012), before resorting to the end-to-end WTRU-to-WTRU relay reselection.

In various embodiments, the present disclosure describes a local WTRU-to-WTRU relay reselection procedure with integrated discovery to facilitate the notified precursor U2U relay of the link failure detecting U2U relay (here, the first relay WTRU 1004) to perform local integrated discovery with the next hop U2U relay of the link failure detecting U2U relay, i.e., the peer U2U relay of the failure link (here, the third relay WTRU 1008).

At 1020, the first end WTRU 1002 and the second end WTRU 1012 may set up hop-by-hop PC5 connections via the first relay WTRU 1004, the second relay WTRU 1006 and the third relay WTRU 1008 for end-to-end communication, and the first end WTRU 1002 and the second end WTRU 1012 are may exchange data traffic via the first relay WTRU 1004, the second relay WTRU 1006 and the third relay WTRU 1008.

At 1021, the second relay WTRU 1006 may detect a link failure between the second relay WTRU 1006 and the third relay WTRU 1008. The second relay WTRU 1006 may determine, from its unicast routing table, the list of downstream end WTRUs whose next hop is the third relay WTRU 1008 before link failure (here, the second end WTRU 1012) and the corresponding precursor (here, the first relay WTRU 1004) for each downstream end WTRU (here, the second end WTRU 1012). For each precursor of downstream end WTRUs (here, the precursor of the second end WTRU 1012 on the second relay WTRU 1006 is the first relay WTRU 1004), the second relay WTRU 1006 may determine a list of upstream end WTRUs (here, the first end WTRU 1002) whose next hop is the considered precursor (here, the first relay WTRU 1004) of downstream end WTRUs (here, the second end WTRU 1012), and whose precursor is the third relay WTRU 1008 before link failure.

At 1022, the second relay WTRU 1006 may transmit a LFN message to each precursor of downstream end WTRUs (here, the first relay WTRU 1004) whose next hop is the third relay WTRU 1008, which may include information of a list of downstream end WTRUs (whose next hop is the third relay WTRU 1008 and whose precursor is the target precursor) and a list of upstream end WTRUs (whose next hop is the considered precursor and whose precursor is the third relay WTRU 1008), and the failure link peer relay of the second relay WTRU 1006 (here, the third relay WTRU 1008). Upon receiving the LFN message from the second relay WTRU 1006, the first relay WTRU 1004 may determine the list of QoS information sets of the first relay WTRU 1004 for the list of identified downstream end WTRUs (here, the second end WTRU 1012) and their identified upstream peer end WTRUs (here, the first end WTRU 1002). For example, the QoS information set of the first relay WTRU 1004 for the second end WTRU 1012 and the identified peer end WTRU of the second end WTRU 1012 (here, the first end WTRU 1002) includes, for end-to-end connections with the second end WTRU 1012 being the source end WTRU in the QoS context of the unicast routing table of the first relay WTRU 1004, the QoS information between the first relay WTRU 1004 and each of the peer target end WTRUs of the second end WTRU 1012 that is in the list of identified upstream end WTRUs (here, the first end WTRU 1002) based on the information in the QoS context. Further, for end-to-end connections with the second end WTRU 1012 being the target end WTRU in the QoS context of the unicast routing table of the first relay WTRU 1004, the QoS information between the first relay WTRU 1004 and the second end WTRU 1012 associated with each of the peer source end WTRUs of the second end WTRU 1012 that is in the list of identified upstream end WTRUs (here, the first end WTRU 1002) based on the information in the QoS context.

At 1023, each precursor of downstream end WTRUs (here, the first relay WTRU 1004) may transmit the LER message and/or the LMR message targeting the failure link peer relay of the second relay WTRU 1006 (here, the third relay WTRU 1008), which may include information of initiating U2U relay (here, the first relay WTRU 1004) and target U2U relay (here, the third relay WTRU 1008), information of the list of identified downstream end WTRUs (here, the second end WTRU 1012) and the list of identified upstream end WTRUs (here, the first end WTRU 1002) received in the LFN message from the second relay WTRU 1006.

In the LMR message, information of the list of next hops (U2U relays and/or downstream end WTRUs) that already have direct PC5 connections with the first relay WTRU 1004 may be included. In addition, the first relay WTRU 1004 may provide the list of the QoS information sets of the first relay WTRU 1004 for the list of identified downstream end WTRUs (here, the second end WTRU 1012) and their identified upstream peer end WTRUs (here, the first end WTRU 1002).

At 1024, the fourth relay WTRU 1010 may transmit the LER message and/or the LMR message targeting the third relay WTRU 1008, which may include information of initiating U2U relay (here, the first relay WTRU 1004) and target U2U relay (here, the third relay WTRU 1008), information of the list of identified downstream end WTRUs (here, the second end WTRU 1012) and the list of identified upstream end WTRUs (here, the first end WTRU 1002) received in the LER message and/or the LMR message from the first relay WTRU 1004. In the LMR message, information of the list of next hops (U2U relays and/or downstream end WTRUs) that already have direct PC5 connections with the fourth relay WTRU 1010 may be included.

At 1025, the third relay WTRU 1008 may establish security with the fourth relay WTRU 1010 if the PC5 connection between the third relay WTRU 1008 and the fourth relay WTRU 1010 has not been established.

At 1026, the third relay WTRU 1008 may transmit the LEA message and/or the LMA message to the fourth relay WTRU 1010, which may include information of initiating U2U relay (here, the first relay WTRU 1004) and target U2U relay (here, the third relay WTRU 1008), information of the list of identified downstream end WTRUs (here, the second end WTRU 1012) and the list of identified upstream end WTRUs (here, the first end WTRU 1002) received in the LER message and/or the LMR message from the fourth relay WTRU 1010 that are routable via the third relay WTRU 1008, the list of the QoS information sets of the third relay WTRU 1008 for the list of identified downstream end WTRUs (here, the second end WTRU 1012) and their identified upstream peer end WTRUs (here, the first end WTRU 1002). In an example, the QoS information set of the third relay WTRU 1008 for the second end WTRU 1012 includes, for end-to-end connections with the second end WTRU 1012 being the source end WTRU in the QoS context of the unicast routing table of the third relay WTRU 1008, the QoS information between the third relay WTRU 1008 and each of the peer target end WTRUs of the second end WTRU 1012 that is in the list of identified upstream end WTRUs (here, the first end WTRU 1002), based on the information in the QoS context. Further, for end-to-end connections with the second end WTRU 1012 being the target end WTRU in the QoS context of the unicast routing table of the third relay WTRU 1008, the QoS information between the third relay WTRU 1008 and the second end WTRU 1012 associated with each of the peer source end WTRUs of the second end WTRU 1012 that is in the list of identified upstream end WTRUs (here, the first end WTRU 1002) based on the information in the QoS context. The fourth relay WTRU 1010 may receive the LEA message and/or the LMA message from the third relay WTRU 1008 and may add a route entry to each downstream end in the list of identified downstream end WTRUs (here, the second end WTRU 1012) in its unicast routing table, with the third relay WTRU 1008 as next hop. In addition, the fourth relay WTRU 1010 may record the third relay WTRU 1008 as the precursor to each upstream end WTRU in the list of identified upstream end WTRUs (here, the first end WTRU 1002) in its unicast routing table.

At 1027, the fourth relay WTRU 1010 may establish security with the first relay WTRU 1004 if the PC5 connection between the fourth relay WTRU 1010 and the first relay WTRU 1004 has not been established. In the security procedure, the first relay WTRU 1004 may provide the list of the QoS information sets of the first relay WTRU 1004 associated with the list of identified downstream end WTRUs received from the second relay WTRU 1006 (here, the second end WTRU 1012) in the LFN message and their identified upstream peer end WTRUs (here, the first end WTRU 1002).

The fourth relay WTRU 1010 may determine a list of QoS information sets between the first relay WTRU 1004 and the third relay WTRU 1008 for the list of identified downstream end WTRUs (here, the second end WTRU 1012) and their identified upstream peer end WTRUs (here, the first end WTRU 1002). In an example, the QoS information set between the first relay WTRU 1004 and the third relay WTRU 1008 for the second end WTRU 1012 and the identified peer end WTRUs of the second end WTRU 1012 (here, the first end WTRU 1002) may be determined. In that, for end-to-end connections with the second end WTRU 1012 being the source end WTRU during link establishment, the fourth relay WTRU 1010 may determine the QoS information between the first relay WTRU 1004 and the third relay WTRU 1008 for the second end WTRU 1012 and the identified peer end WTRUs of the second end WTRU 1012 (here, the first end WTRU 1002) based on the QoS information the between the first relay WTRU 1004 and each of the identified peer target end WTRUs of the second end WTRU 1012 as received in the QoS information set from the first relay WTRU 1004 and the QoS information between the third relay WTRU 1008 and each of the identified peer target end WTRUs of the second end WTRU 1012 as received in the QoS information set from the third relay WTRU 1008.

For end-to-end connections with the second end WTRU 1012 being the target end WTRU during link establishment, the fourth relay WTRU 1010 may determine the QoS information between the first relay WTRU 1004 and the third relay WTRU 1008 for the second end WTRU 1012 and the identified peer end WTRUs of the second end WTRU 1012 (here, the first end WTRU 1002), based on the QoS information between the first relay WTRU 1004 and the second end WTRU 1012 as received in the QoS information set from the first relay WTRU 1004 and the QoS information between the third relay WTRU 1008 and the second end WTRU 1012 as received in the QoS information set from the third relay WTRU 1008, associated with each of the identified peer source end WTRUs of the second end WTRU 1012 (here, the first end WTRU 1002).

The fourth relay WTRU 1010 may determine the list of QoS information sets between the first relay WTRU 1004 and the fourth relay WTRU 1010 and the list of QoS information sets between the fourth relay WTRU 1010 and the third relay WTRU 1008 based on the list of QoS information sets between the first relay WTRU 1004 and the third relay WTRU 1008, for the list of identified downstream end WTRUs (here, the second end WTRU 1012) and their identified upstream peer end WTRUs (here, the first end WTRU 1002).

At 1028, the fourth relay WTRU 1010 may transmit the LMR message to the third relay WTRU 1008 for the QoS flow setup and/or modification, including the list of QoS information sets between the fourth relay WTRU 1010 and the third relay WTRU 1008 for the list of identified downstream end WTRUs (here, the second end WTRU 1012) and their identified upstream peer end WTRUs (here, the first end WTRU 1002). The QoS information set for the second end WTRU 1012 includes the QoS information between the fourth relay WTRU 1010 and the third relay WTRU 1008, for the second end WTRU 1012 and the identified peer end WTRUs of the second end WTRU 1012 (here, the first end WTRU 1002).

At 1029, the third relay WTRU 1008 may transmit the LMA message to the fourth relay WTRU 1010 for QoS flow setup and/or modification, including the list of QoS information sets between the fourth relay WTRU 1010 and the third relay WTRU 1008 for the list of identified downstream end WTRUs (here, the second end WTRU 1012) and their identified upstream peer end WTRUs (here, the first end WTRU 1002).

At 1030, the fourth relay WTRU 1010 may transmit the LEA message and/or the LMA message to the first relay WTRU 1004, which may include information of initiating U2U relay (here, the first relay WTRU 1004) and target U2U relay (here, the third relay WTRU 1008), information of the list of identified downstream end WTRUs (here, the second end WTRU 1012) and the list of identified upstream end WTRUs (here, the first end WTRU 1002) received in the LEA message and/or the LMA message from the third relay WTRU 1008, a list of QoS information sets between the first relay WTRU 1004 and the fourth relay WTRU 1010, considering the list of QoS information sets between the fourth relay WTRU 1010 and the third relay WTRU 1008 received from the third relay WTRU 1008, for the list of identified downstream end WTRUs (here, the second end WTRU 1012) and their identified upstream peer end WTRUs (here, the first end WTRU 1002). The QoS information set between the first relay WTRU 1004 and the fourth relay WTRU 1010 for the second end WTRU 1012 the identified peer end WTRUs of the second end WTRU 1012 includes the QoS information between the first relay WTRU 1004 and the fourth relay WTRU 1010 for the second end WTRU 1012 and each of the identified peer end WTRUs of the second end WTRU 1012 (here, the first end WTRU 1002).

The first relay WTRU 1004 may receive the LEA message and/or the LMA message from the fourth relay WTRU 1010 and may update the route entry to each downstream end in the list of identified downstream end WTRUs (here, the second end WTRU 1012) in its unicast routing table, with the fourth relay WTRU 1010 as the next hop. In addition, the first relay WTRU 1004 may record the fourth relay WTRU 1010 as the precursor to each upstream end WTRU in the list of identified upstream end WTRUs (here, the first end WTRU 1002) in its unicast routing table.

At 1031, the first relay WTRU 1004 may transmit the LMN message to the list of identified upstream end WTRUs, which may include information of the list of identified upstream end WTRU (here, the first end WTRU 1002) and the list of identified downstream end WTRUs (here, the second end WTRU 1012) received in the LFN message from the second relay WTRU 1006 (or alternatively, received in the LEA message and/or the LMA message from the fourth relay WTRU 1010) to facilitate updating of route entries (e.g., hop counts), to the identified downstream end WTRUs along the upstream paths.

The LMN message may be forwarded to each identified upstream end WTRU based on the unicast routing table hop by hop. At each intermediate U2U relay, the received list of identified upstream end WTRUs may be split into multiple sub-lists with each sub-list including identified upstream end WTRUs associated with the same next hop and the sub-list of identified downstream end WTRUs with this next hop as the precursor, and transmitted in a separate the LMN message via the corresponding next hop.

At 1032, the first relay WTRU 1004 may transmit the LMN message, via the fourth relay WTRU 1010, to a list of identified downstream end WTRUs received in the LFN from the second relay WTRU 1006, which may include information of a list of identified downstream end WTRUs (here, the second end WTRU 1012) and the list of identified upstream end WTRUs (here, the first end WTRU 1002) received in the LFN message from the second relay WTRU 1006 (or alternatively, received in the LEA message and/or the LMA message from the fourth relay WTRU 1010), to facilitate updating of route entries (e.g., hop counts) to the identified upstream end WTRUs along the downstream paths.

The fourth relay WTRU 1010 may receive the LMN message from the first relay WTRU 1004 and add a route entry to each upstream end WTRU in the received list of identified upstream WTRUs (here, the second end WTRU 1012) in its unicast routing table, with the first relay WTRU 1004 as next hop. In addition, the fourth relay WTRU 1010 may record the first relay WTRU 1004 as the precursor to each downstream end WTRU in the list of identified downstream end WTRUs (here, the second end WTRU 1012) received from the second relay WTRU 1006 in its unicast routing table.

The third relay WTRU 1008 may receive the LMN message from the fourth relay WTRU 1010 and may add a route entry to each upstream end WTRU in the received list of identified upstream WTRUs (here, the second end WTRU 1012) in its unicast routing table, with the fourth relay WTRU 1010 as next hop. In addition, the third relay WTRU 1008 may record the fourth relay WTRU 1010 as the precursor to each downstream end WTRU in the list of identified downstream end WTRUs (here, the second end WTRU 1012) in its unicast routing table.

The LMN message may be further forwarded to each identified downstream end WTRU based on the unicast routing table hop by hop. At each intermediate U2U relay, the received list of identified downstream end WTRUs may be split into multiple sub-lists with each sub-list including identified downstream end WTRUs associated with the same next hop and a sub-list of identified upstream end WTRUs with this next hop as the precursor, and transmitted in a separate the LMN message via the corresponding next hop.

At 1033, after successful connection setup between the first relay WTRU 1004 and the third relay WTRU 1008 (here, via the fourth relay WTRU 1010) and notifications to the identified upstream end WTRUs (here, the first end WTRU 1002) and downstream end WTRUs (here, the second end WTRU 1012), as well as further Layer 3 and/or Layer 2 end-to-end QoS reconfiguration (as needed), the first end WTRU 1002 and the second end WTRU 1012 may transfer traffic via the newly selected route between the first end WTRU 1002 and the second end WTRU 1012 (here, [the first end WTRU 1002, the first relay WTRU 1004, the fourth relay WTRU 1010, the third relay WTRU 1008, the second end WTRU) 1012]).

If the first relay WTRU 1004 does not receive the LEA message and/or the LMA message after transmitting the LER message and/or the LMR message targeting the third relay WTRU 1008 for a preconfigured period of time.

The first relay WTRU 1004 may transmit a DCR message and/or the LMR message targeting the list of downstream end WTRUs received in the LFN message from the second relay WTRU 1006 (here, the second end WTRU 1012), which may include information of the list of identified downstream end WTRUs and the list of identified upstream end WTRUs (here, the first end WTRU 1002). The remaining local integrated discovery procedures may be performed similar to FIG. 7.

If any of the downstream end WTRUs still cannot be reached, the first relay WTRU 1004 further may transmit the LFN message to each precursor (either an end WTRU or a U2U relay) of the unreachable downstream end WTRUs (based on the unicast routing table of the first relay WTRU 1004), which may include information of the list of the unreachable downstream end WTRUs (whose next hop is the second relay WTRU 1006 and whose precursor is the target precursor) and a corresponding list of upstream end WTRUs (whose next hop is the considered precursor and whose precursor is the second relay WTRU 1006). The notification process may continue until all the identified upstream end WTRUs are reached, similar to the procedure described in FIG. 9.

Alternatively, an intermediate U2U relay receiving the LFN message may perform a local integrated discovery targeting the associated unreachable downstream end WTRUs before transmitting the LFN message further upstream, similar to the local integrated discovery procedure described in FIG. 9. Each notified upstream end WTRU may perform local and/or end-to-end integrated discovery with its peer end WTRUs that are in the received list of unreachable downstream end WTRUs similar to FIG. 7.

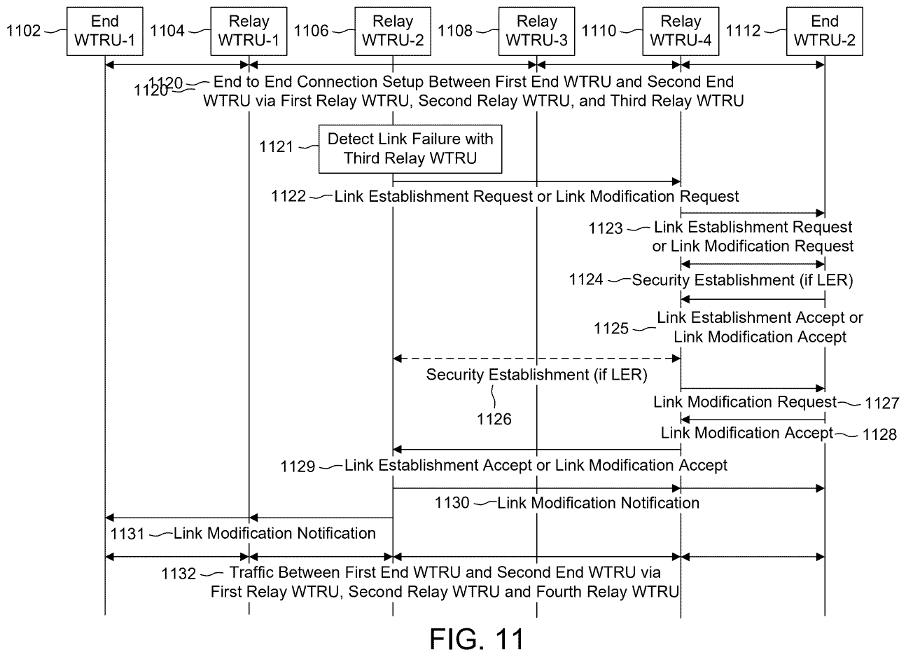

Referring now to FIG. 11, a call flow illustrating an example process for reselection with integrated discovery between a detecting U2U relay and an end WTRU is shown according to one or more embodiments. The process may be performed by a first end WTRU 1102, a first relay WTRU 1104, a second relay WTRU 1106, a third relay WTRU 1108, a fourth relay WTRU 1110, and a second end WTRU 1112. Examples of the first end WTRU 1102, the first relay WTRU 1104, the second relay WTRU 1106, the third relay WTRU 1108, the fourth relay WTRU 1110, and the second end WTRU 1112 include but are not limited to one or more WTRUs, 5G ProSe enabled WTRUs, and/or D2D enabled WTRUs etc. Further, the first end WTRU 1102, the first relay WTRU 1104, the second relay WTRU 1106, the third relay WTRU 1108, the fourth relay WTRU 1110, and the second end WTRU 1112 may include but are not limited to one or more devices in vehicles and/or carried by pedestrians, one or more network devices and/or infrastructure devices etc.

In a WTRU-to-WTRU relay mesh network, the link failure may occur between the pair of intermediate U2U relays due to WTRU mobility and/or RF environmental changes. When this happens, it would be beneficial to have the option for the link failure detecting U2U relay (here, the second relay WTRU 1106) to perform WTRU-to-WTRU relay reselection between itself and end WTRUs on the opposite side of the detecting U2U relay relative to the failure link (to be illustrated as downstream end WTRUs, here, the second end WTRU 1112) without changing the remaining parts of the end-to-end routes with their peer end WTRUs on the same side of the detecting U2U relay relative to the failure link (to be illustrated as upstream end WTRUs, here, the first end WTRU 1102), before resorting to the end-to-end WTRU-to-WTRU relay reselection.

In various embodiments, the present disclosure provides a local WTRU-to-WTRU relay reselection procedure with integrated discovery to facilitate the link failure detecting U2U relay (here, the second relay WTRU 1106) to perform local integrated discovery with the end WTRUs on the opposite side of the detecting U2U relay relative to the failure link (here, the second end WTRU 1112).

At 1120, the first end WTRU 1102 and the second end WTRU 1112 set up hop-by-hop PC5 connections via the first relay WTRU 1104, the second relay WTRU 1106 and the third relay WTRU 1108 for end-to-end communication, and first end WTRU 1102 and second end WTRU 1112 are exchanging data traffic via the first relay WTRU 1104, the second relay WTRU 1106 and the third relay WTRU 1108.

At 1121, the second relay WTRU 1106 may detect the link failure between the second relay WTRU 1106 and the third relay WTRU 1108. The second relay WTRU 1106 may determine, from its unicast routing table, a list of upstream end WTRUs whose precursor is the third relay WTRU 1108 before link failure (here, the first end WTRU 1102) and a list of downstream end WTRUs whose next hop is the third relay WTRU 1108 before link failure (here, the second end WTRU 1112), a list of QoS information sets of the second relay WTRU 1106 for the list of identified downstream end WTRUs (here, the second end WTRU 1112) and their identified upstream peer end WTRUs (here, the first end WTRU 1102). In an example, the QoS information set of the second relay WTRU 1106 for the second end WTRU 1112 and the identified peer end WTRUs of the second end WTRU 1112 includes for end-to-end connections with the second end WTRU 1112 being the source end WTRU in the QoS context of the unicast routing table of the second relay WTRU 1106, the QoS information between the second relay WTRU 1106 and each of the peer target end WTRUs of the second end WTRU 1112 that is in the list of identified upstream end WTRUs (here, the first end WTRU 1102) based on the information in the QoS context. For end-to-end connections with the second end WTRU 1112 being the target end WTRU in the QoS context of the unicast routing table of the second relay WTRU 1106, the QoS information between the second relay WTRU 1106 and the second end WTRU 1112 associated with each of the peer source end WTRUs of the second end WTRU 1112 that is in the list of identified upstream end WTRUs (here, the first end WTRU 1102) based on the information in the QoS context.

At 1122, the second relay WTRU 1106 may transmit the LER message and/or the LMR message, targeting the list of identified downstream end WTRUs (here, the second end WTRU 1112), which may include information of initiating U2U relay (here, the second relay WTRU 1106), information of the list of identified downstream end WTRUs (here, the second end WTRU 1112) and the list of identified upstream end WTRUs (here, the first end WTRU 1102). In the LMR message, information of the list of next hops (U2U relays and/or downstream end WTRUs) that already have direct PC5 connections with the second relay WTRU 1106 may be included. In addition, the second relay WTRU 1106 provides the list of the QoS information sets of the second relay WTRU 1106 for the list of identified downstream end WTRUs (here, the second end WTRU 1112) and their identified upstream peer end WTRUs (here, the first end WTRU 1102).

At 1123, the fourth relay WTRU 1110 may transmit the LER message and/or the LMR message targeting the list of downstream end WTRUs (here, the second end WTRU 1112) received from the second relay WTRU 1106, which may include information of initiating U2U relay (here, the second relay WTRU 1106), information of the list of identified downstream end WTRUs (here, the second end WTRU 1112) and the list of identified upstream end WTRUs (here, the first end WTRU 1102) received in the LER message and/or the LMR message from the second relay WTRU 1106. In the LMR message, information of the list of next hops (U2U relays and/or downstream end WTRUs) that already have direct PC5 connections with the fourth relay WTRU 1110 may be included.

At 1124, a responding target downstream end WTRU (here, the second end WTRU 1112) may establish security with the fourth relay WTRU 1110 if the PC5 connection between the second end WTRU 1112 and the fourth relay WTRU 1110 has not been established. In an example with the first end WTRU 1102 may be the identified downstream end WTRU.

At 1125, the second end WTRU 1112 may transmit the LEA message and/or the LMA message to the fourth relay WTRU 1110, which may include information of initiating U2U relay (here, the second relay WTRU 1106), information of the second end WTRU 1112 and the list of identified peer end WTRUs of the second end WTRU 1112 (here, the first end WTRU 1102) that are in the list of upstream end WTRUs received in the LER message and/or the LMR message from the fourth relay WTRU 1110, the end-to-end QoS information set for the second end WTRU 1112 and the identified peer end WTRUs of the second end WTRU 1112, which includes, for end-to-end connections with the second end WTRU 1112 being the source end WTRU during link establishment, the end-to-end QoS information between the second end WTRU 1112 and each of the identified peer target end WTRUs of the second end WTRU 1112 (here, the first end WTRU 1102). For end-to-end connections with the second end WTRU 1112 being the target end WTRU during the link establishment, the end-to-end QoS information=NA between the second end WTRU 1112 and each of the identified peer source end WTRUs of the second end WTRU 1112 (here, the first end WTRU 1102). The fourth relay WTRU 1110 may receive the LEA message and/or the LMA message from the second end WTRU 1112 and add a route entry to the second end WTRU 1112 in its unicast routing table. After the PC5 connection setup with the fourth relay WTRU 1110, the second end WTRU 1112 may receive the IP address from the fourth relay WTRU 1110 or assign link local IP address.

At 1126, the fourth relay WTRU 1110 may establish security with the second relay WTRU 1106 if the PC5 connection between the fourth relay WTRU 1110 and the second relay WTRU 1106 has not been established. In the security procedure, the second relay WTRU 1106 may provide the QoS information set of the second relay WTRU 1106 for the second end WTRU 1112 and the identified peer end WTRUs of the second end WTRU 1112 (here, the first end WTRU 1102) to the fourth relay WTRU 1110.

The fourth relay WTRU 1110 may determine the QoS information set between the second relay WTRU 1106 and the second end WTRU 1112 associated with each of the identified peer end WTRUs of the second end WTRU 1112 (here, the first end WTRU 1102). In that, for end-to-end connections with the second end WTRU 1112 being the source end WTRU during link establishment, the fourth relay WTRU 1110 may determine the QoS information between the second relay WTRU 1106 and the second end WTRU 1112 based on the end-to-end QoS information associated with each of the identified peer end WTRUs of the second end WTRU 1112 as received in the end-to-end QoS information set from the second end WTRU 1112 and the QoS information between the second relay WTRU 1106 and each of the identified peer end WTRUs of the second end WTRU 1112 as received in the QoS information set from the second relay WTRU 1106. For end-to-end connections with the second end WTRU 1112 being the target end WTRU during the link establishment, the fourth relay WTRU 1110 may determine the QoS information between the second relay WTRU 1106 and the second end WTRU 1112 associated with each of the identified peer source end WTRUs of the second end WTRU 1112 based on the information received in the QoS information set from the second relay WTRU 1106.

The fourth relay WTRU 1110 may determine the QoS information set between the second relay WTRU 1106 and the fourth relay WTRU 1110 and the QoS information set between the fourth relay WTRU 1110 and the second end WTRU 1112 based on the QoS information set between the second relay WTRU 1106 and the second end WTRU 1112, for the second end WTRU 1112 and the identified peer end WTRUs of the second end WTRU 1112 (here, the first end WTRU 1102).

At 1127, the fourth relay WTRU 1110 may transmit the LMR message to the second end WTRU 1112 for QoS flow setup and/or modification, including the QoS information set between the fourth relay WTRU 1110 and the second end WTRU 1112, associated with the identified peer end WTRUs of the second end WTRU 1112 (here, the first end WTRU 1102).

At 1128, the second end WTRU 1112 may transmit the LMA message to the fourth relay WTRU 1110 for QoS flow setup and/or modification, including the QoS information set between the fourth relay WTRU 1110 and the second end WTRU 1112, associated with the identified peer end WTRUs of the second end WTRU 1112 (here, the first end WTRU 1102).

At 1129, the fourth relay WTRU 1110 may transmit the LEA message and/or the LMA message to the second relay WTRU 1106, which may include information of initiating U2U relay (here, the second relay WTRU 1106), information of the second end WTRU 1112 and the list of peer end WTRUs of the second end WTRU 1112 (here, the first end WTRU 1102) received in the LEA message and/or the LMA message from the second end WTRU 1112, the QoS information set between the second relay WTRU 1106 and the fourth relay WTRU 1110, considering the QoS information set between the fourth relay WTRU 1110 and the second end WTRU 1112 received from the second end WTRU 1112, for the second end WTRU 1112 and the identified peer end WTRUs of the second end WTRU 1112 (here, the first end WTRU 1102). The second relay WTRU 1106 may receive the LEA message and/or the LMA message from the fourth relay WTRU 1110 and may add a route entry to the second end WTRU 1112 in its unicast routing table, with the fourth relay WTRU 1110 as next hop. In addition, the second relay WTRU 1106 may record the fourth relay WTRU 1110 as the precursor to the received list of identified peer end WTRUs of the second end WTRU 1112 in its unicast routing table. The LEA message and/or the LMA message may further include the IP address of the second end WTRU 1112.

At 1130, the second relay WTRU 1106 may transmit, via the fourth relay WTRU 1110, the LMN message to the second end WTRU 1112, which may include information of the second end WTRU 1112 and the list of peer end WTRUs of the second end WTRU 1112 (here, the first end WTRU 1102) received in the LEA message and/or the LMA message from the fourth relay WTRU 1110, to facilitate updating of route entries (e.g., hop counts) to the identified peer end WTRUs of the second end WTRU 1112 on the fourth relay WTRU 1110 and the second end WTRU 1112.

The fourth relay WTRU 1110 may receive the LMN message from the second relay WTRU 1106 and add a route entry to each of the identified peer end WTRUs of the second end WTRU 1112 (here, the first end WTRU 1102) received in the LMN message from the second relay WTRU 1106 or, alternatively, in the LEA message and/or the LMA message from the second end WTRU 1112 in its unicast routing table, with the second relay WTRU 1106 as next hop. In addition, the fourth relay WTRU 1110 may record the second relay WTRU 1106 as the precursor to the second end WTRU 1112 in its unicast routing table.

The second end WTRU 1112 may receive the LMN message from the fourth relay WTRU 1110 and may update its unicast routing table with a destination to each of its identified peer end WTRU received in the LMN message from the fourth relay WTRU 1110 or, alternatively, transmitted in the LEA message and/or the LMA message to the fourth relay WTRU 1110, with the fourth relay WTRU 1110 as next hop. In addition, the fourth relay WTRU 1110 may record the second end WTRU 1112 as the precursor to the identified peer end WTRUs of the second end WTRU 1112 in its unicast routing table.

At 1131, the second relay WTRU 1106 may transmit the LMN message to a list of identified peer end WTRUs of the second end WTRU 1112 (here, the first end WTRU 1102) received in the LEA message and/or the LMA message from the fourth relay WTRU 1110, which may include information of the second end WTRU 1112 and the list of identified peer end WTRUs of the second end WTRU 1112 (here, the first end WTRU 1102), to facilitate updating of route entries (e.g., hop counts) to the second end WTRU 1112 along the upstream paths to the identified peer end WTRUs of the second end WTRU 1112. The LMN message may further include the IP address of the second end WTRU 1112.

The LMN message may be forwarded to each identified peer end WTRU of the second end WTRU 1112 based on the unicast routing table hop by hop. At each intermediate U2U relay, the received list of identified peer end WTRUs of the second end WTRU 1112 may be split into multiple sub-lists with each sub-list including identified peer end WTRUs of the second end WTRU 1112 associated with the same next hop and sent in a separate LMN message via the corresponding next hop.

At 1132, after successful connection setup between the second relay WTRU 1106 and the second end WTRU 1112 (here, via the fourth relay WTRU 1110) and notifications to the identified peer end WTRUs of the second end WTRU 1112 (here, the first end WTRU 1102), as well as any further Layer 3 and/or Layer 2 end-to-end QoS reconfiguration (as needed), the first end WTRU 1102 and the second end WTRU 1112 may transfer traffic via the newly selected route between the first end WTRU 1102 and the second end WTRU 1112 (here, [the first end WTRU 1102, the first relay WTRU 1104, the second relay WTRU 1106, the fourth relay WTRU 1110, the second end WTRU 1112]).

If the second relay WTRU 1106 does not receive the LEA message and/or the LMA message associated with any of the target downstream end WTRUs after transmitting the LER message and/or the LMR message for a preconfigured period of time.

The second relay WTRU 1106 may transmit the LFN message to each precursor (here, the first relay WTRU 1104) of the unreachable downstream end WTRUs whose next hop is the third relay WTRU 1108, which may include information of a list of unreachable downstream end WTRUs (whose next hop is the third relay WTRU 1108 and whose precursor is the target precursor) and a corresponding list of upstream end WTRUs (whose next hop is the target precursor (here, the first relay WTRU 1104) and whose precursor is the third relay WTRU 1108).

If the receiving precursor of the second relay WTRU 1106 is one of the included upstream end WTRUs, the receiving upstream end WTRU may perform local and/or end-to-end integrated discovery with its peer end WTRUs that are in the received list of unreachable downstream end WTRUs similar to FIG. 7.

If the receiving precursor of the second relay WTRU 1106 (here, the first relay WTRU 1104) acts as a U2U relay (note that a precursor may serve as both an end WTRU and a U2U relay), the receiving precursor further may transmit the LFN message to each of its own precursors of the received unreachable downstream end WTRUs (based on its own unicast routing table), which may include information of a sub-list of the unreachable downstream end WTRUs received from the second relay WTRU 1106 and a corresponding sub-list of the received upstream end WTRUs (whose next hop is the considered precursor of the first relay WTRU 1104 and whose precursor is the second relay WTRU 1106).

Alternatively, the first relay WTRU 1104 may perform a local integrated discovery similar to FIG. 9 targeting a list of unreachable downstream end WTRUs received in the LFN message from the second relay WTRU 1106 (here, the second end WTRU 1112), before transmitting the LFN message further upstream. The notification process may continue until all the identified upstream end WTRUs are reached.

Each notified upstream end WTRU (here, the first end WTRU 1102) may perform local and/or end-to-end integrated discovery with its peer end WTRUs (here, the second end WTRU 1112) that are in the received list of unreachable downstream end WTRUs similar to FIG. 7.

The process may also be applied in the node failure scenario (e.g., the third relay WTRU 1108 may be shut down or run out of battery), which may be detected by the onset of release procedure or by the missing of consecutive keep-alive messages.

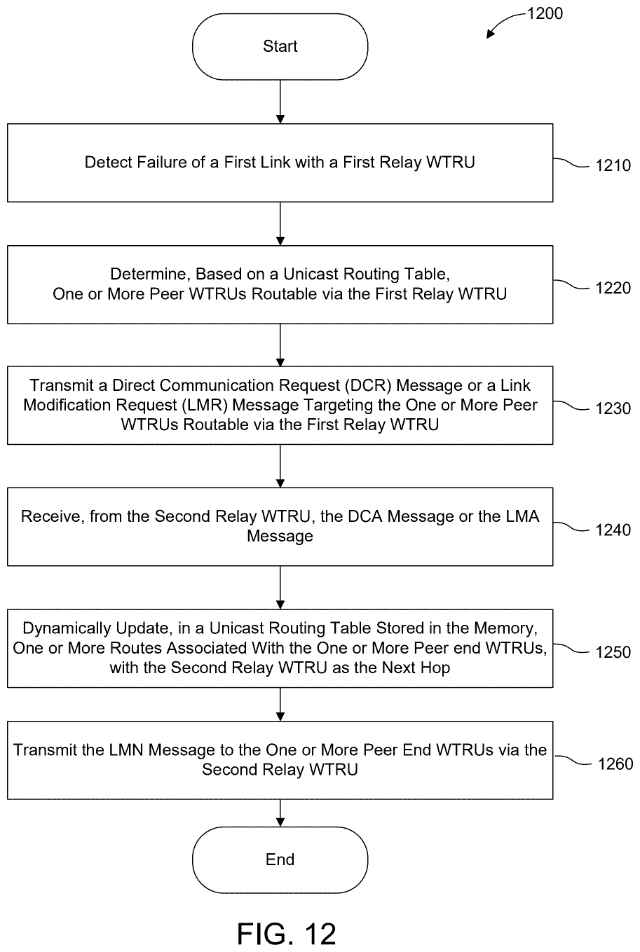

Referring to FIG. 12, a flowchart illustrating a process 1200 for local WTRU-TO-WTRU relay reselection with integrated discovery is shown according to one or more embodiments. The process 1200 may be performed by the first end WTRU.

At 1210, the first end WTRU may detect failure of the first link with the first relay WTRU.

At 1220, the first end WTRU may determine, based on the unicast routing table, the one or more peer WTRUs routable via the first relay WTRU.

At 1230, the first end WTRU may transmit the DCR message and/or the LMR message targeting the one or more peer WTRUs routable via the first relay WTRU. The DCR message and/or the LMR message is indicative of one or more identities of the one or more peer end WTRUs and/or the end-to-end quality of service (QoS) information set associated with the one or more peer end WTRUs.

In an example, the second relay WTRU which knows an active route to any of its peer end WTRUs originally routed through the failure link may perform security establishment with the first end WTRU, in response to the DCR message.

At 1240, the first end WTRU may receive, from the second relay WTRU, the DCA message or the LMA message, indicative of one or more identities of the one or more peer end WTRUs and/or the QoS information set between the first end WTRU and the second relay WTRU associated with the one or more peer end WTRUs. After receiving the DCA or LMA message, the first end WTRU has established the second link with the second relay WTRU capable of routing to the one or more peer end WTRUs.

At 1250, the first end WTRU may dynamically update, in a unicast routing table stored in the memory, one or more routes associated with the one or more peer end WTRUs, with the second relay WTRU as the next hop.

At 1260, the first end WTRU may transmit the LMN message to the one or more peer end WTRUs via the second relay WTRU.

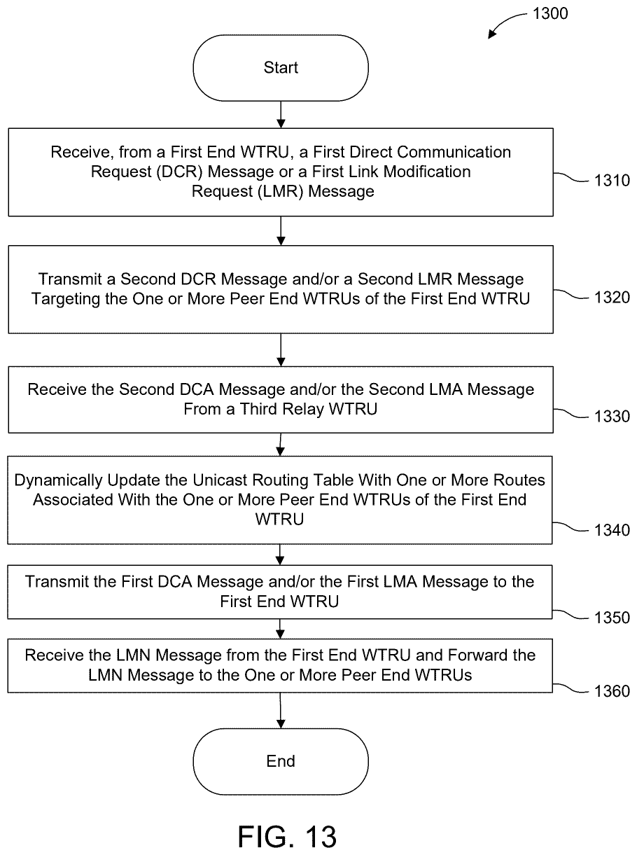

Referring to FIG. 13, a flowchart illustrating a process 1300 for local WTRU-TO-WTRU relay reselection with integrated discovery is shown according to one or more embodiments. The process 1300 may be performed by a second relay WTRU. In one or more non-limiting implementations, the second relay WTRU may be implemented as the fourth relay WTRU 710 as shown in FIG. 7.

At 1310, the second relay WTRU may receive, from the first end WTRU, a first DCR message and/or the first LMR message. The first DCR message and/or the first LMR message is indicative of one or more identities of one or more peer WTRUs. The first DCR message and/or the first LMR message is further indicative of the an end-to-end QoS information set associated with the one or more peer end WTRUs.

At 1320, if the second relay WTRU does not have an active route to any of the peer end WTRUs of the first end WTRU originally routed through the failure link, the second relay WTRU may transmit a second DCR message and/or a second LMR message targeting the one or more peer end WTRUs of the first end WTRU not routable by the second relay WTRU, indicative of the QoS information set between the second relay WTRU and the third relay WTRU associated with the one or more peer end WTRUs. A third relay WTRU which knows an active route to any of its peer end WTRUs of the first end WTRU received in the DCR or LMR message from the second relay WTRU may perform security establishment with the second relay WTRU, in response to the DCR message.

At 1330, the second relay WTRU may receive the second DCA message and/or the second LMA message from a third relay WTRU. The DCA message or the LMA message may be indicative of the one or more peer end WTRUs of the first end WTRU that can and/or cannot be routed via the third relay WTRU and/or the QoS information set between the second relay WTRU and the third relay WTRU associated with the one or more peer end WTRUs that can be routed via the third relay WTRU.

At 1340, the second relay WTRU may dynamically update the unicast routing table with one or more routes associated with the one or more peer end WTRUs of the first end WTRU.

At 1350, the second relay WTRU may transmit the first DCA message and/or the first LMA message to the first end WTRU. The first DCA message or the first LMA message are indicative of the one or more peer end WTRUs of the first end WTRU that can and/or cannot be routed via the second relay WTRU based on its unicast routing table, and/or the QoS information set between the first end WTRU and the second relay WTRU associated with the one or more peer end WTRUs that can be routed via the second relay WTRU.

At 1360, the second relay WTRU may receive the LMN message from the first end WTRU, and forward the LMN message to the one or more peer WTRUs based on its unicast routing table.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a memory;
a transceiver; and
a processor, wherein the transceiver and the processor are configured to:
detect failure of a first link with a first relay WTRU,
determine, based on a unicast routing table, one or more peer end WTRUs routable via the first relay WTRU,
transmit a direct communication request (DCR) message or a link modification request (LMR) message targeting the one or more peer end WTRUs, and
receive, from a second relay WTRU that is capable of routing to the one or more peer end WTRUs, a direct communication accept (DCA) message or a link modification accept (LMA) message.

2. The WTRU of claim 1, wherein at least one of: the DCR message or the LMR message is indicative of one or more of:
one or more identities of the one or more peer end WTRUs, or
a quality of service (QoS) information set associated with the one or more peer end WTRUS.

3. The WTRU of claim 1, wherein at least one of: the DCA message or the LMA message is indicative of one or more of:
a first set of identities of a first set of peer end WTRUs that can be routed via the second relay WTRU,
a second set of identities of a second set of peer end WTRUs that cannot be routed via the second relay WTRU, or
a quality of service (QoS) information set between the WTRU and the second relay WTRU associated with the first set of peer end WTRUs.

4. The WTRU of claim 1, wherein the transceiver and the processor are further configured to:
dynamically update, in the unicast routing table stored in the memory, one or more routes associated with the one or more peer end WTRUs.

5. The WTRU of claim 1, wherein the transceiver and the processor are further configured to:
transmit a link modification notification (LMN) message to the one or more peer end WTRUs via the second relay WTRU.

6. A method for use in a wireless transmit/receive unit (WTRU), the method comprising:
detecting failure of a first link with a first relay WTRU;
determining, based on a unicast routing table, one or more peer end WTRUs routable via the first relay WTRU;
transmitting a direct communication request (DCR) message or a link modification request (LMR) message targeting the one or more peer end WTRUs; and
receiving, from a second relay WTRU that is capable of routing to the one or more peer end WTRUs, a direct communication accept (DCA) message or a link modification accept (LMA) message.

7. The method of claim 6, wherein at least one of: the DCR message or the LMR message is indicative of one or more of:
one or more identities of the one or more peer end WTRUs, or
a quality of service (QoS) information set associated with the one or more peer end WTRUS.

8. The method of claim 6, wherein at least one of: the DCA message or the LMA message is indicative of one or more of:
a first set of identities of a first set of peer end WTRUs that can be routed via the second relay WTRU,
a second set of identities of a second set of peer end WTRUs that cannot be routed via the second relay WTRU, or
a quality of service (QoS) information set between the WTRU and the second relay WTRU associated with the first set of peer end WTRUs.

9. The method of claim 6, the method further comprising:
dynamically updating, in the unicast routing table, one or more routes associated with the one or more peer end WTRUs.

10. The method of claim 6, the method further comprising:
transmitting a link modification notification (LMN) message to the one or more peer end WTRUs via the second relay WTRU.

11. A wireless transmit/receive unit (WTRU) comprising:
a memory;
a transceiver; and
a processor, wherein the transceiver and the processor are configured to:
receive, from a first end WTRU, a first direct communication request (DCR) message or a first link modification request (LMR) message, wherein at least one of: the first DCR message or the first LMR message is indicative of one or more identities of one or more peer end WTRUs of the first end WTRU,
transmit a second DCR message or a second LMR message to a third relay WTRU, and
receive, from the third relay WTRU, a direct communication accept (DCA) message based on the second DCR message or receive, from the third relay WTRU, a link modification accept (LMA) message based on the second LMR message.

12. The WTRU of claim 11, wherein at least one of: the DCR message or the LMR message is further indicative of: a quality of service (QoS) information set associated with the one or more peer end WTRUs.

13. The WTRU of claim 11, wherein at least one of: the second DCR message or the second LMR message is indicative of one or more of:
one or more identities of one or more peer end WTRUs of the first end WTRU, or
a quality of service (QoS) information set associated with the one or more peer end WTRUs of the first end WTRU.

14. The WTRU of claim 11, wherein at least one of: the DCA message or the LMA message is indicative of one or more of:
a first set of identities of a first set of peer end WTRUs that can be routed via the third relay WTRU,
a second set of identities of a second set of peer end WTRUs that cannot be routed via the third relay WTRU, or
a quality of service (QoS) information set between the WTRU and the third relay WTRU associated with the first set of peer end WTRUs.

15. The WTRU of claim 11, wherein the transceiver and the processor are further configured to:
dynamically update a unicast routing table with one or more routes associated with the one or more peer end WTRUs.

16. The WTRU of claim 13, wherein the transceiver and the processor are further configured to:
transmit a first DCA message or a first LMA message to the first end WTRU.

17. The WTRU of claim 16, wherein the LMA message is a second LMA message and the DCA message is a second DCA message.

18. The WTRU of claim 17, wherein at least one of: the first DCA message or the first LMA message is indicative of one or more of:
a third set of identities of a third set of peer end WTRUs that can be routed via the WTRU,
a fourth set of identities of a fourth set of peer end WTRUs that cannot be routed via the WTRU, or
a quality of service (QoS) information set between the first end WTRU and the WTRU associated with the third set of peer end WTRUs.

19. The WTRU of claim 15, wherein the transceiver and the processor are further configured to receive a link modification notification (LMN) message from the first end WTRU.

20. The WTRU of claim 19, wherein the transceiver and the processor are further configured to forward the LMN message to the one or more peer end WTRUs.
